(19) United States
(12) Patent Application Publication
(10) Pub. No.: US 2016/0212721 A1
(43) Pub. Date: Jul. 21, 2016

(54) METHOD AND APPARATUS FOR SELECTING A SYNCHRONIZATION SIGNAL SOURCE FOR SIDELINK COMMUNCATIONS

(71) Applicant: Sharp Laboratories of America, Inc., Camas, WA (US)

(72) Inventors: Jia Sheng, Vancouver, WA (US); John Michael Kowalski, Camas, WA (US)

(21) Appl. No.: 14/995,339

(22) Filed: Jan. 14, 2016

Related U.S. Application Data
(60) Provisional application No. 62/104,365, filed on Jan. 16, 2015.

(51) Int. Cl. H04W 56/00; H04W 48/18; H04W 48/16; H04W 76/02

(52) U.S. Cl. CPC H04W 56/0015; H04W 76/023; H04W 48/18; H04W 48/16; H04W 84/047

(57) ABSTRACT

A wireless terminal (30) comprises a receiver (44) and a relay-inclusive D2DSS source prioritization processor (40). The receiver (44) is configured to receive signals over a radio interface. The processor (40) is configured make a selection of a synchronization source from which to obtain synchronization information for use in device-to-device (D2D)/sidelink (SL) interaction when the wireless terminal is out-of-coverage of a radio access network by considering the fact that at least one of plural candidate synchronization sources is a UE-to-network relay (UTNR) wireless terminal.

This application claims the priority and benefit of U.S. Provisional Patent Application 62/104,365, entitled “METHOD AND APPARATUS FOR SELECTING A SYNCHRONIZATION SIGNAL SOURCE FOR DEVICE-TO-DEVICE COMMUNICATIONS”, filed Jan. 16, 2015, which is incorporated herein by reference in its entirety.

### TECHNICAL FIELD

The technology relates to wireless communications, and particularly to synchronization for wireless device-to-device (D2D)/sidelink (SL) communications.

### BACKGROUND

When two user equipment terminals (e.g., mobile communication devices) of a cellular network or other telecommunication system communicate with each other, their data path typically goes through the operator network. The data path through the network may include base stations and/or gateways. If the devices are in close proximity with each other, their data path may be routed locally through a local base station. In general, communications between a network node such as a base station and a wireless terminal is known as “wide area network” (“WAN”) or “Cellular communication”.

It is also possible for two user equipment terminals in close proximity to each other to establish a direct link without the need to go through a base station. Telecommunications systems may use or enable device-to-device (“D2D”) communication, in which two or more user equipment terminals directly communicate with one another. In D2D communication, voice and/or data traffic (referred to herein as “communication signals”) from one user equipment terminal to one or more other user equipment terminals may not be communicated through a base station or other network control device of a telecommunication system. Device-to-device (D2D) communication has more recently also become known as “sidelink direct communication” or even “sidelink” communications, and accordingly is sometimes abbreviated as “SLD” or “SL”. As such, device-to-device (D2D), sidelink direct, and sidelink are used interchangeably herein but all have the same meaning, as sometimes indicated by notations such as D2D/SL, etc.

“Device-to-Device communication” or “sidelink direct communication” thus refers to a radio technology that enables devices to communicate directly with each other, that is without routing the data paths through a network infrastructure. Potential application scenarios include, among others, proximity-based services where devices detect their proximity and subsequently trigger different services (such as social applications triggered by user proximity, advertisements, local exchange of information, smart communication between vehicles, etc.). Other applications include public safety support, where devices provide at least local connectivity even in case of damage to the radio infrastructure.

Various aspects of D2D/SL communications are described in one or more of the following, all of which are incorporated herein by reference in their entirety:

U.S. patent application Ser. No. 14/660,528, filed Mar. 17, 2015;
U.S. patent application Ser. No. 14/660,491, filed Mar. 17, 2015;
U.S. patent application Ser. No. 14/660,559, filed Mar. 17, 2015;
U.S. patent application Ser. No. 14/660,587, filed Mar. 17, 2015;
U.S. patent application Ser. No. 14/660,622, filed Mar. 17, 2015;
U.S. patent application Ser. No. 14/749,898 filed Jun. 25, 2015;
U.S. patent application Ser. No. 14/818,855, filed Aug. 5, 2015;
U.S. patent application Ser. No. 14/859,648, filed Sep. 21, 2015;
U.S. patent application Ser. No. 14/862,291, filed Sep. 23, 2015;
U.S. Provisional Patent Application 62/145,492, filed Apr. 9, 2015;
U.S. Provisional Patent Application 62/145,597, filed Apr. 9, 2015; and,
U.S. Provisional Patent Application 62/202,642, filed Aug. 7, 2015.

What is needed, and an object of the technology disclosed herein, are apparatus, methods, and techniques to facilitate synchronization of remote (e.g., out of coverage) wireless terminals, including synchronization to UE-to-Network relays (UTNR) for both D2D/SL discovery and D2D/SL communications.

### SUMMARY

Aspects the technology disclosed herein concern a wireless terminal which comprises a receiver and a relay-inclusive D2DSS source prioritization processor and method for operating such receiver. The receiver is configured to receive signals over a radio interface. The processor is configured make a selection of a synchronization source from which to obtain synchronization information for use in device-to-device (D2D)/sidelink (SL) interaction when the wireless terminal is out-of-coverage of a radio access network by considering the fact that at least one of plural candidate synchronization sources is a UE-to-network relay (UTNR) wireless terminal.

### BRIEF DESCRIPTION OF THE DRAWINGS

The foregoing and other objects, features, and advantages of the technology disclosed herein will be apparent from the following more particular description of preferred embodiments as illustrated in the accompanying drawings in which reference characters refer to the same parts throughout the various views. The drawings are not necessarily to scale, emphasis instead being placed upon illustrating the principles of the technology disclosed herein.

FIG. 1 is a diagrammatic view of an example generic embodiment of a radio communications environment in which a device-to-device (D2D)/sidelink direct (SLD)-capable remote wireless terminal makes a selection of a D2D/SL synchronization source from plural candidate synchronization sources.

FIG. 2 is a schematic view of an example embodiment of a device-to-device (D2D)/sidelink direct (SLD)-capable remote wireless terminal comprising a relay-inclusive D2D/SL synchronization signal (D2DSS/SLDSS) source prioritization processor.

FIG. 3A and FIG. 3B are flowcharts depicting basic, example acts or steps involved in generic methods of relay-inclusive D2D/SL synchronization source selection according to an example embodiment and mode.

FIG. 3C is a flowchart depicting basic, example acts or steps involved in a mode of relay-inclusive D2D/SL synchronization source selection for selecting among plural UE-to-network relay wireless terminals according to an example embodiment and mode.

FIG. 4 is a diagrammatic view showing different situations in which relay-inclusive D2D/SL synchronization signal (D2DSS/SLDSS) source prioritization may be implemented.

FIG. 5A and FIG. 5B are diagrammatic views showing differing formats of a physical D2D/SL synchronization channel (PD2DSCH) channel wherein content of the synchronization information according to differing respective embodiments is configured to indicate that a source of the synchronization information is a UE-to-network relay (UTNR) wireless terminal.

FIG. 6A, FIG. 6B, and FIG. 6C are diagrammatic view showing example implementations of relay-inclusive D2D/SL synchronization signal (D2DSS/SLDSS) source prioritization for initial synchronization, in the case of device-to-device (D2D)/sidelink (SL) communication without D2D/SL discovery, in differing example embodiments and modes.

FIG. 7 is a diagrammatic view of a modification of the example generic embodiment of a radio communications environment of FIG. 1 and showing further wireless terminals which make a selection of a D2D/SL synchronization source.

FIG. 8 is a diagrammatic view of showing a UE-to-network relay (UTNR) wireless terminal configured to transmit with the D2D/SL synchronization signal (D2DSS) of its discovery signal an indication of whether or not the wireless terminal is in network coverage and whether the wireless terminal can serve as a UE-to-network relay (UTNR) wireless terminal.

FIG. 9 is a flowchart showing basic, representative acts or steps of a method of operating a wireless terminal which operates at least partially in a D2D/SL discovery phase.

FIG. 10 is a schematic view illustrating an example embodiment of electronic circuitry that may comprise a device-to-device (D2D)/sidelink (SL) wireless terminal.

### DETAILED DESCRIPTION

In the following description, for purposes of explanation and not limitation, specific details are set forth such as particular architectures, interfaces, techniques, etc. in order to provide a thorough understanding of the technology disclosed herein. However, it will be apparent to those skilled in the art that the technology disclosed herein may be practiced in other embodiments that depart from these specific details. That is, those skilled in the art will be able to devise various arrangements which, although not explicitly described or shown herein, embody the principles of the technology disclosed herein and are included within its spirit and scope. In some instances, detailed descriptions of well-known devices, circuits, and methods are omitted so as not to obscure the description of the technology disclosed herein with unnecessary detail. All statements herein reciting principles, aspects, and embodiments of the technology disclosed herein, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that block diagrams herein can represent conceptual views of illustrative circuitry or other functional units embodying the principles of the technology. Similarly, it will be appreciated that any flow charts, state transition diagrams, pseudocode, and the like represent various processes which may be substantially represented in computer readable medium and so executed by a computer or processor, whether or not such computer or processor is explicitly shown.

As used herein, the term “device-to-device (“D2D”) communication” and sidelink direct (“SLD”) or sidelink (“SL”) communication may refer to a mode of communication between or among wireless terminals that operate on a cellular network or other telecommunications system in which the communication data traffic from one wireless terminal to another wireless terminal does not pass through a centralized base station or other device in the cellular network or other telecommunications system. Communication data is sent using communication signals and can include voice communications or data communications intended for consumption by a user of a wireless terminal. Communication signals may be transmitted directly from a first wireless terminal to a second wireless terminal via D2D/SL communication. In various aspects, all, some, or none of the control signaling related to the D2D/SL packet transmission may be managed or generated by the underlying core network or base station. In additional or alternative aspects, a receiver user equipment terminal may relay communication data traffic between a transmitter user equipment terminal and one or more additional receiver user equipment terminals.

As used herein, the term “core network” can refer to a device, group of devices, or sub-system in a telecommunication network that provides services to users of the telecommunications network. Examples of services provided by a core network include aggregation, authentication, call switching, service invocation, gateways to other networks, etc.

As used herein, the term “wireless terminal” and/or “wireless terminal device” can refer to any electronic device used to communicate voice and/or data via a telecommunications system, such as (but not limited to) a cellular network. Other terminology used to refer to wireless terminals and non-limiting examples of such devices can include user equipment terminal, UE, mobile station, mobile device, access terminal, subscriber station, mobile terminal, remote station, user terminal, terminal, subscriber unit, cellular phones, smart phones, personal digital assistants (“PDAs”), laptop computers, netbooks, e-readers, wireless modems, etc.

As used herein, the term “access node”, “node”, or “base station” can refer to any device or group of devices that facilitates wireless communication or otherwise provides an interface between a wireless terminal and a telecommunications system. A non-limiting example of a base station can include, in the 3GPP specification, a Node B (“NB”), an enhanced Node B (“eNB”), a home eNB (“HeNB”) or some other similar terminology. Another non-limiting example of a base station is an access point. An access point may be an electronic device that provides access for wireless terminal to a data network, such as (but not limited to) a Local Area Network (“LAN”), Wide Area Network (“WAN”), the Internet, etc. Although some examples of the systems and methods disclosed herein may be described in relation to given standards (e.g., 3GPP Releases 8, 9, 10, 11, and/or 12), the scope of the present disclosure should not be limited in this regard. At least some aspects of the systems and methods disclosed herein may be utilized in other types of wireless communication systems.

As used herein, the term “telecommunication system” or “communications system” can refer to any network of devices used to transmit information. A non-limiting example of a telecommunication system is a cellular network or other wireless communication system.

As used herein, the term “cellular network” can refer to a network distributed over cells, each cell served by at least one fixed-location transceiver, such as a base station. A “cell” may be any communication channel that is specified by standardization or regulatory bodies to be used for International Mobile Telecommunications-Advanced (“IMTAdvanced”). All or a subset of the cell may be adopted by 3GPP as licensed bands (e.g., frequency band) to be used for communication between a base station, such as a Node B, and a UE terminal. A cellular network using licensed frequency bands can include configured cells. Configured cells can include cells of which a UE terminal is aware and in which it is allowed by a base station to transmit or receive information.

Device-to-device (D2D)/sidelink (SL) communication may be used in networks implemented according to any suitable telecommunications standard. A non-limiting example of such as standard is the 3rd Generation Partnership Project (“3GPP”) Long Term Evolution (“LTE”). The 3GPP LTE is the name given to a project to improve the Universal Mobile Telecommunications System (“UMTS”) mobile phone or device standard to cope with future requirements. The 3GPP standard is a collaboration agreement that aims to define globally applicable technical specifications and technical reports for third and fourth generation wireless communication systems. The 3GPP may define specifications for next generation mobile networks, systems, and devices. In one aspect, UMTS has been modified to provide support and specification for the Evolved Universal Terrestrial Radio Access (“E-UTRA”) and Evolved Universal Terrestrial Radio Access Network (“E-UTRAN”). E-UTRAN is another non-limiting example of a telecommunications standard with which D2D/SL communication may be used.

The terms “in-coverage” and “out-of-coverage” are frequently used in describing D2D/SL technology. In-coverage and out-of-coverage situations are generally described in, e.g., U.S. patent application Ser. No. 14/660,491, filed Mar. 17, 2015, entitled “DETECTING OUT-OF-COVERAGE TRANSITION FOR WIRELESS DEVICE-TO-DEVICE COMMUNICATIONS”, which is incorporated herein by reference in its entirety.

In the above regard, on some occasions a device-to-device (D2D)/sidelink (SL) communications may be under network control or “in-coverage”, meaning that one or more of the wireless terminals involved in the device-to-device (D2D)/sidelink (SL) communications may be within range of radio frequencies utilized by a node or cell of a radio access network (RAN). When “in-coverage” care must be taken that use of radio resources of the device-to-device (D2D)/sidelink (SL) communications not cause interference with the other types of communications on-going in the cell, e.g., communications between the node and the wireless terminals served by the node. When in-coverage, in conjunction with device-to-device (D2D)/sidelink (SL) communications a wireless terminal obtains a device-to-device (D2D)/sidelink (SL) grant from the subframe S transmitted by the network. The device-to-device (D2D)/sidelink (SL) grant specifies radio resources that wireless terminal is permitted to use for device-to-device (D2D)/sidelink (SL) communication with another wireless terminal, e.g., second wireless terminal.

When out-of-coverage, for device-to-device (D2D)/sidelink (SL) communications a wireless terminal is no longer entitled to use the network radio resources which are dynamically allocated by the network node, but instead for device-to-device (D2D)/sidelink (SL) communications (e.g., with other wireless terminals) must use resources selected by the wireless terminal from a pre-configured pool of radio resources (e.g., a wireless terminal selected resource mode). Thus, if the wireless terminal is out of network coverage, it may use pre-assigned resources for communications.

There are two general types or components of D2D/SL services: D2D/SL discovery and D2D/SL communication. As used herein, “D2D interaction” refers to any of D2D/SL discovery, D2D/SL communication, or both D2D/SL discovery and D2D/SL communication.

D2D Discovery enables a wireless terminal to use the LTE radio interface to discover the presence of other D2D-capable devices in its vicinity and, where permitted, to ascertain certain information about them. D2D/SL Communication is the facility for D2D/SL wireless terminals to use the LTE radio interface to communicate directly with each other, without routing the traffic through the LTE network. The network controls the radio resource allocation and security of the connections. The current assumptions related to D2D/SL communication is that a wireless terminal within network coverage uses resources for D2D/SL discovery and communication assigned by the controlling node.

D2D/SL communication and D2D/SL discovery are not necessarily dependent on each other. For example, in D2D/SL broadcast communication, the D2D/SL wireless terminals can transmit/receive D2D/SL signals without discovering other wireless terminals in their proximity. D2D/SL discovery can also be done independently by D2D/SL wireless terminals to detect whether there are other wireless terminals which they are interested in being in their proximity. But this does not mean that there must be communications following the discovery, unless the information carried by discovery signal indicates and initiates subsequent communications.

In legacy LTE networks, at the physical layer, a wireless terminal (e.g., UE) needs to determine time and frequency parameters that are necessarily to demodulate the downlink and to transmit uplink signals with the correct timing by a series of synchronization procedures. Legacy LTE synchronization signals are described, e.g., in 3GPP TS 36.211 (incorporated herein by reference), for example section 6.11, et. seq. Legacy LTE synchronization signals comprise a primary synchronization signal (PSS), which is a sequence generated from a frequency-domain Zadoff-Chu sequence, and a secondary synchronization signal (SSS), which is an interleaved concatenation of two sequences which are then scrambled with a scrambling sequence. A combination of PSS and SSS is used to signify a physical-layer cell identity which is an identifier of the source (e.g., base station) of the synchronization signal. See, e.g., U.S. patent application Ser. No. 14/818,855, filed Aug. 5, 2015, entitled “SYNCHRONIZATION SIGNALS FOR DEVICE-TO-DEVICE COMMUNICATIONS”, which is incorporated herein by reference in its entirety.

For D2D/SL scheme, because of the existing out of coverage communications, the synchronization source may not necessarily be an eNodeB. In fact, the synchronization source may instead be a wireless terminal (UE). Moreover, synchronization signals from different sources (e.g., eNodeB or UEs) may be relayed to other UEs, e.g., through a series of hops or stratum levels.

A wireless terminal (UE) participating in D2D/SL communications may receive multiple synchronization signals, and thus may need to choose an appropriate and accurate synchronization signal to use for its own timing. That is, the wireless terminal needs to distinguish such information when receiving multiple synchronization signals, so as to get correct timing for communications, especially for an out of coverage scenario.

Both D2D/SL discovery and D2D/SL communication require synchronization. To date, for D2D/SL communications the 3GPP has defined three scenarios: in coverage (IC), partial coverage, and out of coverage (LLC). But for D2D/SL discovery only in-coverage has been defined by 3GPP.

The currently existing D2D/SL synchronization signal (D2DSS/SLDSS) source prioritization rules require that a wireless terminal needing to select a synchronization source, e.g., a D2D/SL synchronization signal source, make selection in the following prioritized order (listed with highest priority first and then in decreasing priority order):
1. eNBs that meet the S-criterion as defined in 3GPP TS 36.304. The S-criterion refers to cell selection and reselection signal strength/quality criteria to indicate whether the cell is suitable for the UE.
2. wireless terminals (e.g., UEs) which are within network coverage. If there are plural UEs within network coverage, highest priority is given to the device-to-device (D2D)/sidelink (SL) synchronization source having the D2D/SL synchronization signal (D2DSS/SLDSS) received with the highest synchSourceThresh measurement. As used herein, “synchSourceThresh” refers to a signal strength/quality measurement to measure D2D/SL synchronization source signal strength/quality. A comparable measurement in legacy LTE is the measurement on reference signal strength/quality associated with PSS/SSS. In D2D, the D2D/SL synchronization source is not limited to eNB, so it could be reference signal strength/quality associated with synchronization signal, or signal strength/quality of the D2D/SL synchronization signal (D2DSS/SLDSS) itself.
3. wireless terminals (e.g., UEs) which are out of network coverage and which are transmitting a D2D/SL synchronization signal (D2DSS/SLDSS) comprising a sequence (D2DSSue_net) which indicates that the timing reference is originally from a base station device. If D2DSSs/SLDSSs are received from plural such UEs, highest priority is given to the device-to-device (D2D)/sidelink (SL) synchronization source having the D2D/SL synchronization signal (D2DSS/SLDSS) received with the highest synchSourceThresh measurement.
4. wireless terminals (e.g., UEs) which are out of network coverage and which are transmitting a D2D/SL synchronization signal (D2DSS/SLDSS) comprising a sequence (D2DSSue_oon) which indicates that the timing reference is not originally from a base station device. If D2DSSs/SLDSSs are received from plural such UEs, highest priority is given to the device-to-device (D2D)/sidelink (SL) synchronization source having the D2D/SL synchronization signal (D2DSS/SLDSS) received with the highest synchSourceThresh measurement.
5. If none of the above are selected, the UE uses its own internal clock.

The existing D2D/SL synchronization signal (D2DSS/SLDSS) source prioritization rules may suffice for broadcast D2D/SL communications with in coverage D2D/SL direct discovery, but is generally not workable for the future. In this regard, when anticipating future developments such as D2D/SL relay communications, unicast communications and group communications, as well as introducing partial coverage and out of coverage discovery, the situation becomes more complicated, and the agreed 3GPP solution is no longer sufficient. In fact, the current synchronization sources selection may in the future cause D2D/SL discovery and communication to be performed improperly if there is unreliable synchronization.

Apparatus, methods, and techniques are provided herein to facilitate synchronization of remote (e.g., out of coverage) wireless terminals, including synchronization to UE-to-Network relays (UTNR) for both D2D/SL discovery and D2D/SL communications.

In one of its aspects the technology disclosed herein concerns a wireless terminal which comprises a receiver and a relay-inclusive D2DSS source prioritization processor. The receiver is configured to receive signals over a radio interface. The processor is configured make a selection of a synchronization source from which to obtain synchronization information for use in device-to-device (D2D)/sidelink (SL) interaction when the wireless terminal is out-of-coverage of a radio access network by considering the fact that at least one of plural candidate synchronization sources is a UE-to-network relay (UTNR) wireless terminal.

In an example embodiment and mode the processor is configured to prioritize the UE-to-network relay (UTNR) wireless terminal over a non-UTNR wireless terminal in the selection of synchronization source.

In an example embodiment and mode the processor is configured to prioritize the UE-to-network relay (UTNR) wireless terminal over the non-UTNR wireless terminal during an initial synchronization procedure.

In an example embodiment and mode the processor is configured to prioritize the UE-to-network relay (UTNR) wireless terminal over the non-UTNR wireless terminal during a re-synchronization procedure.

In an example embodiment and mode the processor is configured to select as the synchronization source a UE-to-network relay (UTNR) wireless terminal which has a highest received signal strength when the wireless terminal receives synchronization signals from plural UTNR wireless terminals.

In an example embodiment and mode the processor is configured to make a determination from content of the synchronization information that a source of the synchronization information is a UE-to-network relay (UTNR) wireless terminal.

In an example embodiment and mode the content pertinent to the determination comprises a flag in a primary D2D synchronization channel.

In an example embodiment and mode the content pertinent to the determination comprises a bit in a reserved portion of a PD2DSCH channel.

In an example embodiment and mode the content pertinent to the determination comprises a relay-indicative sequence comprising the synchronization information, the relay-indicative sequence belonging to a relay-indicative subset of synchronization sequences.

In an example embodiment and mode the processor is configured to determine that at least one of plural candidate synchronization sources is a UE-to-network relay (UTNR) wireless terminal by detecting an indication in a discovery signal from the at least one candidate synchronization source that the at least one candidate synchronization source is a UE-to-network relay (UTNR) wireless terminal.

In another of its aspects the technology disclosed herein concerns a method in a wireless terminal. The method comprises receiving synchronization information over a radio interface from plural respective synchronization sources including a UE-to-network relay (UTNR) wireless terminal and a non-UTNR wireless terminal; and making a selection of a synchronization source from which to obtain synchronization information for use in device-to-device (D2D)/sidelink (SL) interaction when the wireless terminal is out-of-coverage of a radio access network by considering the fact that at least one of plural candidate synchronization sources is a UE-to-network relay (UTNR) wireless terminal.

In an example mode the method further comprises prioritizing the UE-to-network relay (UTNR) wireless terminal over a non-UTNR wireless terminal in the selection of the synchronization source.

In an example mode the method further comprises prioritizing the UE-to-network relay (UTNR) wireless terminal over the non-UTNR wireless terminal during an initial synchronization procedure.

In an example mode the method further comprises prioritizing the UE-to-network relay (UTNR) wireless terminal over the non-UTNR wireless terminal during a re-synchronization procedure.

In an example mode the method further comprises selecting as the synchronization source a UE-to-network relay (UTNR) wireless terminal which has a highest received signal strength when the wireless terminal receives synchronization signals from plural UTNR wireless terminals.

In an example mode the method further comprises making a determination from content of the synchronization information that a source of the synchronization information is a UE-to-network relay (UTNR) wireless terminal.

In an example mode the content pertinent to the determination comprises a flag in a primary D2D synchronization channel.

In an example mode the content pertinent to the determination comprises a bit in a reserved portion of a PD2DSCH channel.

In an example mode the content pertinent to the determination comprises a relay-indicative sequence comprising the synchronization information, the relay-indicative sequence belonging to a relay-indicative subset of synchronization sequences.

In an example mode the method further comprises determining that at least one of plural candidate synchronization sources is a UE-to-network relay (UTNR) wireless terminal by detecting an indication in a discovery signal from the at least one candidate synchronization source that the at least one candidate synchronization source is a UE-to-network relay (UTNR) wireless terminal.

In another of its aspects the technology disclosed herein concerns a wireless terminal comprising a transmitter which is configured to transmit a discovery signal over a radio interface and a processor. The processor is configured to include in the discovery signal an indication that the wireless terminal is a UE-to-network relay (UTNR) wireless terminal.

In an example embodiment and mode the discovery signal further includes an indication of whether the wireless terminal is in network coverage or out of network coverage. In an example implementation the indication of whether the wireless terminal is in network coverage or out of network coverage comprises a PD2DSCH channel.

In an example embodiment and mode the wireless terminal participates in Model A discovery and the discovery signal is a request direct discovery signal.

In an example embodiment and mode the wireless terminal participates in Model B discovery and the discovery signal is a response direct discovery signal.

In another of its aspects the technology disclosed herein concerns a method of operating a wireless terminal comprising transmitting a discovery signal over a radio interface; and including in the discovery signal an indication that the wireless terminal is a UE-to-network relay (UTNR) wireless terminal.

In an example mode the method further comprises including an indication of whether the wireless terminal is in network coverage or out of network coverage. In an example implementation the indication of whether the wireless terminal is in network coverage or out of network coverage comprises a PD2DSCH channel.

In an example embodiment and mode the wireless terminal participates in Model A discovery and the discovery signal is a request direct discovery signal.

In an example embodiment and mode the wireless terminal participates in Model B discovery and the discovery signal is a response direct discovery signal.

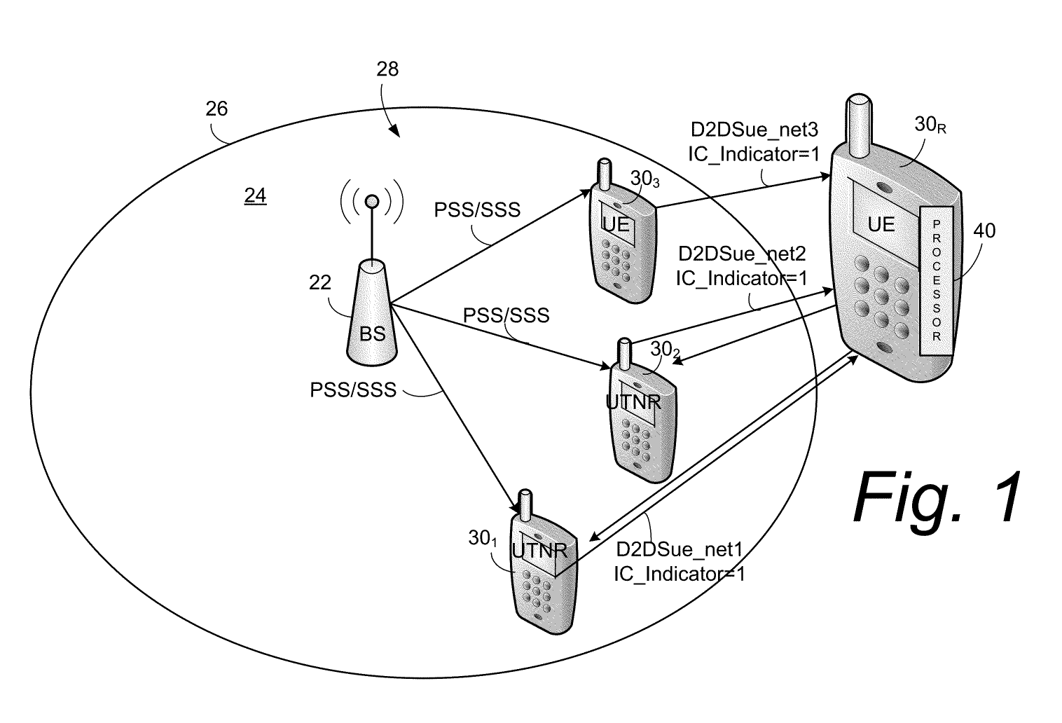

FIG. 1 shows a generic radio communications environment in which a remote device-to-device (D2D)/sidelink direct (SLD)-capable wireless terminal (e.g., remote UE) makes a selection of a D2D/SL synchronization source from plural candidate synchronization sources. In particular, generic radio communications environment 20 of FIG. 1 illustrates base station 22 which, in 3GPP Long Term Evolution (LTE) parlance, is also termed “eNodeB”. The base station 22 serves cell 24, cell 24 being essentially the extent of transmission/reception capabilities of base station 22.

The base station 22 forms part of infrastructure of a radio access network, which typically includes many other base stations serving respective other cells. To facilitate understanding it will be assumed that the radio access network comprises the one base station 22 serving its one cell 24, which simplifies depiction of coverage of the network as being essentially the perimeter 26 of cell 24. In other words, inside perimeter 26 is “in-coverage”, e.g., in network coverage; outside of perimeter 26 is “out-of-coverage”, e.g., outside of network coverage. It is again emphasized that typically a network is much larger than one cell, as a network typically comprises many cells, with the perimeters of the remotest ones of such cells forming a network perimeter that delineates in-coverage and out-of-coverage for the network. But in the simplified illustration of FIG. 1, in-coverage and out-of-coverage for the network is delineated by perimeter 26, which serves as both cell perimeter and network perimeter. Since in FIG. 1 the perimeter 26 defines the extent of the network, the interior of the perimeter is indicated for sake of illustrating network 28.

FIG. 1 further illustrates that communications environment 20 is inhabited by plural wireless terminals 30, also known as mobile stations, user equipments (UEs), etc., as explained herein. FIG. 1 particularly shows three wireless terminals 30₁, 30₂, and 30₃ which are in-coverage of network 28, as well as wireless terminal 30_{R} which is depicted as being out-of-coverage of network 28. Wireless terminal 30R is a “remote” wireless terminal, meaning that it is out-of-coverage of a radio access network. Assuming that wireless terminal 30_{R} is D2D-capable, wireless terminal 30_{R} potentially may interact with three wireless terminals 30₁, 30₂, and 30₃ using device-to-device (D2D)/sidelink (SL) communications.

FIG. 1 further shows that base station 22 is a synchronization source for each of the three wireless terminals 30₁, 30₂, and 30₃. In this regard FIG. 1 shows that the synchronization signal from base station 22 may comprise a primary synchronization signal (PSS), or both a primary synchronization signal (PSS) and a secondary synchronization signal (SSS).

It so happens in the FIG. 1 scenario that wireless terminal 30₁ and wireless terminal 30₂ are configured to act as device-to-device (D2D)/sidelink (SL) relay terminals, e.g., UE-to-network relays (UTNRs). For a particular wireless terminal to act as a UE-to-network relay (UTNR), that wireless terminal must first be configured (e.g., by the network) to function as a UE-to-network relay (UTNR). Relay nodes in general are described in 3GPP release 10, e.g., 3GPP TR 36.806, TS 36.116, TS 36.216. In device-to-device (D2D)/sidelink (SL) technology the network may configure a UTNR to expand its coverage so it can virtually re-include an out-of-coverage UE in coverage again.

As shown in FIG. 1, each of wireless terminal 30₁ and wireless terminal 30₂ may act as a UE-to-network relay (UTNR) synchronization source for wireless terminal 30_{R}. In so doing, the synchronization signal from wireless terminal 30₁ is represented in FIG. 1 as comprising a sequence D2DSSue_net1 and including an in-coverage indicator “IC_Indicator”. As previously explained, sequence comprising a synchronization signal in which the timing reference is originally from a base station device has the notation “D2DSSue_net”. The fact that the synchronization signal from wireless terminal 30₁ includes the sequence D2DSSue_net1 (with “net1” being associated with or indicative of wireless terminal 30₁) enables another wireless terminal to determine that the synchronization signal is from wireless terminal 30₁. The in-coverage indicator “IC_Indicator” having a value IC_Indicator=1 indicates that the wireless terminal 30₁ is in network coverage. Similarly, the synchronization signal from wireless terminal 30₂ is represented in FIG. 1 as comprising a sequence D2DSSue_net2 and also including IC_Indicator=1. The fact that the synchronization signal from wireless terminal 30₂ includes the sequence D2DSSue_net2 (with “net2” being associated with or indicative of wireless terminal 30₂) enables another wireless terminal to determine that the synchronization signal is from wireless terminal 30₂.

On the other hand, wireless terminal 30₃ may act as a normal, e.g., non-UTNR, wireless terminal synchronization source for wireless terminal 30_{R}. The synchronization signal from wireless terminal 30₃ is represented in FIG. 1 as comprising a sequence D2DSSue_net3 and including IC_Indicator=1. The fact that the synchronization signal from wireless terminal 30₃ includes the sequence D2DSSue_net3 (with “net3” being associated with or indicative of wireless terminal 30₃) enables another wireless terminal to determine that the synchronization signal is from wireless terminal 30₃.

Receiving potentially three synchronization signals, e.g., a synchronization signal from each of wireless terminal 30₁, wireless terminal 30₂, and wireless terminal 30₃, a selection of synchronization source must be made for wireless terminal 30_{R} in order to obtain a synchronization timing reference for 30_{R}.

In accordance with existing D2DSS source prioritization rules the choice of synchronization source for 30_{R} must necessarily be the synchronization source whose synchronization signal has the highest received power strength measurement. Detection of use of received power strength measurement is similar to received signal received power (RSRP), which is used for selecting the D2D/SL synchronization signal (D2DSS/SLDSS) with the highest synchSourceThresh measurement, for example. If the D2D/SL synchronization signal (D2DSS/SLDSS) transmitted from wireless terminal 30₃ were to have the highest synchSourceThresh measurement, the wireless terminal 30_{R} would use the synchronization timing reference from wireless terminal 30₃.

There may be situations in which wireless terminal 30_{R} wants to communicate with network via a UE-to-Network relay. In such situations terminals 30₁ and 30₂ act may act as an eNB extension, so to speak. If the purpose of remote terminal 30_{R} is not to communicate with terminal 30₃, but instead to communicate with base station (eNB) 22, access to terminal 30₃ does not mean that remote terminal 30R can communicate with eNB 22, since wireless terminal 30₃ does not have a relay function. As an illustrative example, suppose that a remote wireless terminal 30_{R} is operated by a fire rescue team member/first responder, and a wireless terminal 30₃ is an ordinary citizen. When first responder remote wireless terminal 30_{R} wants to communicate to his fire rescue commander in coverage, such communication should be through wireless terminals 30₁ or 30₂ which are also members of the fire rescue team, so the wireless terminals of the fellow fire rescuers can transfer the words from remote wireless terminal 30_{R} to eNB 22, and no matter where the commander may be located. Then, once the commander is in coverage, the commander can hear what the fire rescuer of remote wireless terminal 30_{R} says through the eNB 22. By contrast, the ordinary citizen on wireless terminal 30₃ can do nothing telephonically.

In situations such as that illustrated above, when remote wireless terminal 30_{R} wants to communicate with network via a UE-to-Network relay, wireless terminal 30_{R} may have different timing from wireless terminal 30₁ or wireless terminal 30₂. Moreover, when wireless terminal 30_{R} wants to communicate with network via a UE-to-Network relay, it may turn out that wireless terminal 30₁ or wireless terminal 30₂ has a different D2D/SL frame number (DFN) as well

In contrast to the prior practice, when in an environment including an UE-to-network relay (UTNR) the wireless terminal 30_{R} of the technology disclosed herein does not arbitrarily follow the existing D2D/SL synchronization signal (D2DSS/SLDSS) source prioritization rules which are described above. Rather, relay-inclusive D2D/SL synchronization signal (D2DSS/SLDSS) source prioritization rules as described herein are implemented in selection of a synchronization source for wireless terminal 30_{R}. In an example embodiment and mode, the wireless terminal 30R comprises a processor 40 which implements relay-inclusive D2D/SL synchronization signal (D2DSS/SLDSS) source prioritization rules in selection of a synchronization source for wireless terminal 30_{R}. The processor 40 for wireless terminal 30R may also be called a relay-inclusive D2D/SL synchronization signal (D2DSS/SLDSS) source prioritization processor 40. The technology disclosed herein facilitates device-to-device (D2D)/sidelink (SL) synchronization source selection for a partial coverage scenario and out-of-coverage scenario, and scenario which includes UE-to-network relaying.

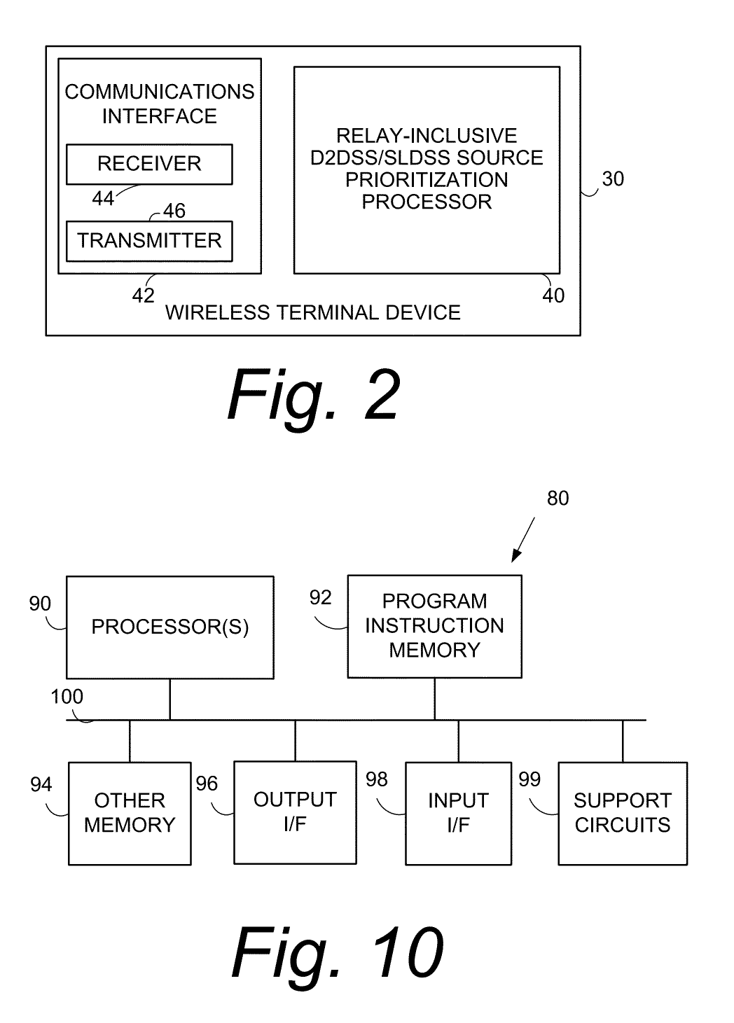

FIG. 2 shows example structure of a wireless terminal which implements relay-inclusive D2D/SL synchronization signal (D2DSS/SLDSS) source prioritization rules. As mentioned above, the remote wireless terminal comprises relay-inclusive D2D/SL synchronization signal (D2DSS/SLDSS) source prioritization processor 40. In one of its aspects, relay-inclusive D2D/SL synchronization signal (D2DSS/SLDSS) source prioritization processor 40 is configured to prioritize a UE-to-network relay (UTNR) wireless terminal over a non-UTNR wireless terminal in a selection of synchronization source from which to obtain synchronization information for use in device-to-device (D2D)/sidelink (SL) interaction when the wireless terminal is out-of-coverage of a radio access network.

In addition to relay-inclusive D2D/SL synchronization signal (D2DSS/SLDSS) source prioritization processor 40, wireless terminal 30_{R} may comprise communication interface 42. The communication interface 42 may comprise receiver 44 and transmitter 46 which enables wireless terminal 30_{R} to receive and send information, e.g., data and signals, over an air or radio interface to other communication units, such as base station 22 (when in-coverage) and other wireless terminals using device-to-device (D2D)/sidelink (SL) communications, either when in-coverage or when out-of-coverage. Through receiver 44 the communication interface 42 of wireless terminal 30_{R} obtains synchronization signals from various synchronization sources. As indicated earlier, selection of a proper one of potential plural synchronization sources is a task of relay-inclusive D2D/SL synchronization signal (D2DSS/SLDSS) source prioritization processor 40. It will be understood that wireless terminal 30R may comprise other functionalities or units for preforming other activities of a wireless terminal.

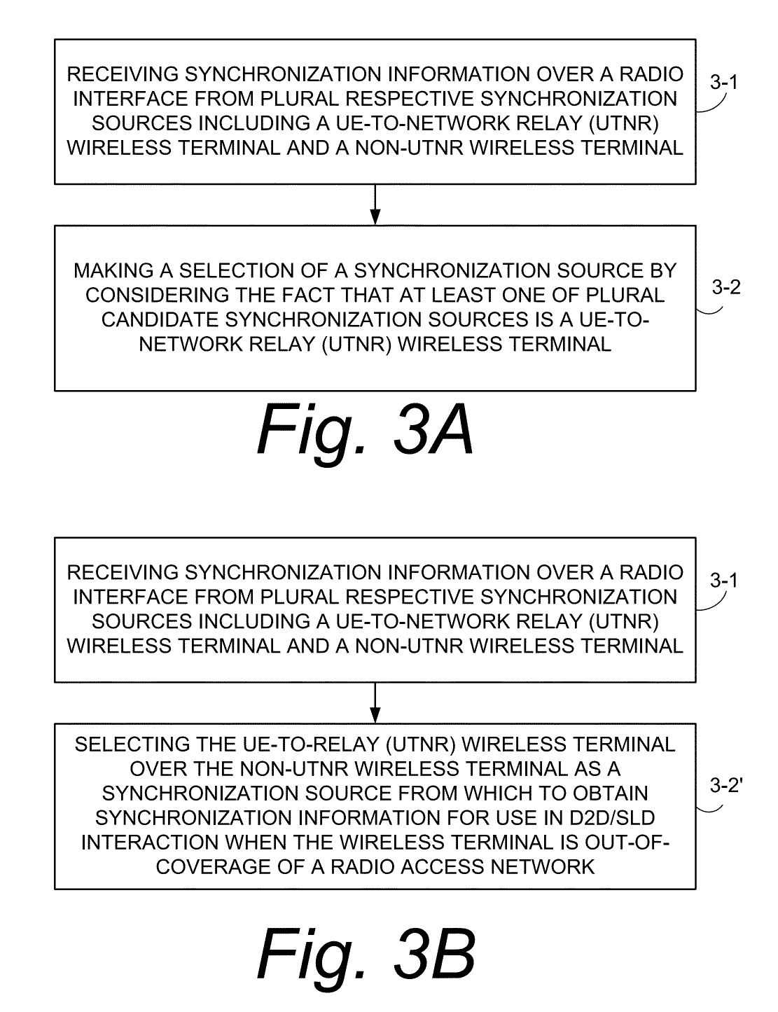

FIG. 3A shows example acts or steps involved in a generic method of relay-inclusive D2D/SL synchronization source selection according to an example embodiment and mode. Act 3-1 comprises receiving synchronization information over a radio interface from plural respective synchronization sources including a UE-to-network relay (UTNR) wireless terminal and a non-UTNR wireless terminal. For example, in the particular environment of FIG. 1 the wireless terminal 30R receives synchronization signals from each of wireless terminal 30₁, wireless terminal 30₂, and wireless terminal 30₃, with wireless terminal 30₁ and wireless terminal 30₂ being UE-to-network relay (UTNR) wireless terminals and wireless terminal 30₃ being a non-UTNR wireless terminal.

Act 3-2 comprises making a selection of a synchronization source from which to obtain synchronization information for use in device-to-device (D2D)/sidelink (SL) interaction when the wireless terminal is out-of-coverage of a radio access network by considering the fact that at least one of plural candidate synchronization sources is a UE-to-network relay (UTNR) wireless terminal. In the example embodiment and mode shown in FIG. 3B, corresponding act 3-2′ comprises selecting the UE-to-relay (UTNR) wireless terminal over the non-UTNR wireless terminal as a synchronization source from which to obtain synchronization information for use in device-to-device (D2D)/sidelink (SL) interaction when the wireless terminal is out-of-coverage of a radio access network.

The selection of act 3-2 of FIG. 3A or act 3-2′ of FIG. 3B may be performed by relay-inclusive D2D/SL synchronization signal (D2DSS/SLDSS) source prioritization processor 40. For example, in the particular environment of FIG. 1, the relay-inclusive D2D/SL synchronization signal (D2DSS/SLDSS) source prioritization processor 40 of wireless terminal 30R may select one of UE-to-network relay (UTNR) wireless terminal 30₁ or UE-to-network relay (UTNR) wireless terminal 30₂ over the non-UTNR wireless terminal 30₃ as the synchronization source from which to obtain synchronization information for device-to-device (D2D)/sidelink (SL) interaction.

While the situation of FIG. 1 is covered by the generic method of FIG. 3A and the implementation of FIG. 3B, it may also be described by the mode of FIG. 3C which shows an additional act 3-3. Act 3-3 comprises selecting as the synchronization source a UE-to-network relay (UTNR) wireless terminal which has a highest received signal strength when the wireless terminal receives synchronization signals from plural UTNR wireless terminals. For example, in the particular environment of FIG. 1 should the synchronization signal from UE-to-network relay (UTNR) wireless terminal 30₂ be stronger than the synchronization signal from UE-to-network relay (UTNR) wireless terminal 30₁, in accordance with act 3-3 the relay-inclusive D2D/SL synchronization signal (D2DSS/SLDSS) source prioritization processor 40 would select UE-to-network relay (UTNR) wireless terminal 30₂ as the synchronization source for wireless terminal 30_{R}.

As used herein, “synchronization” broadly includes both initial synchronization (initial synchronization mode/procedure) and re-synchronization (re-synchronization mode/procedure). When a wireless terminal wants to communicate with other wireless terminals, the wireless terminal needs early on to acquire initial timing information for synchronization. This “initial” synchronization may be with a base station or with a wireless terminal that serves as head of a cluster, e.g., head of a group of wireless terminals that communicate among themselves, or even with other wireless terminals with which direct peer-to-peer communication is anticipated as may occur in unicast communication without any base station or cluster head coverage. Without initial synchronization, the wireless terminal is not able to obtain timing information and therefore could not decide the frame/slot structure of the received signal, and accordingly could not obtain any information (either signals or data) from the frame. Therefore, only after initial synchronization would a remote wireless terminal such as wireless terminal 30R be able to ascertain whether a received synchronization signal (D2D/SL synchronization signal (D2DSS/SLDSS)) is from a UE-to-network relay (UTNR) or not.

Re-synchronization, on the other hand, occurs after the UE has already been initially synchronized to some base station or cluster head wireless terminal. Various aspects of Re-synchronization are described further below.

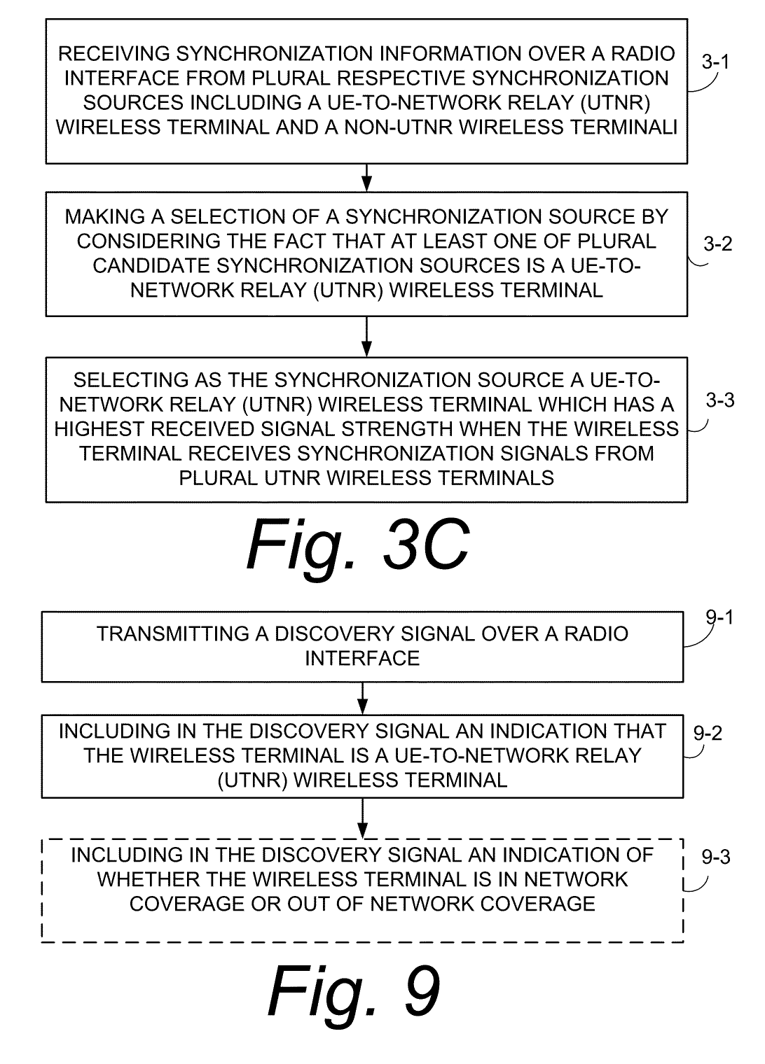

Relay-inclusive D2D/SL synchronization signal (D2DSS/SLDSS) source prioritization processor 40 of wireless terminal 30_{R} may thus implement relay-inclusive D2D/SL synchronization signal (D2DSS/SLDSS) source prioritization rules for initial synchronization (both with and without discovery), for re-synchronization, or for both initial synchronization and re-synchronization. FIG. 4 shows that relay-inclusive D2D/SL synchronization signal (D2DSS/SLDSS) source prioritization processor 40 of wireless terminal 30_{R} may thus implement relay-inclusive D2D/SL synchronization signal (D2DSS/SLDSS) source prioritization rules for several different situations: (1) relay-inclusive D2D/SL synchronization signal (D2DSS/SLDSS) source prioritization for initial synchronization without discovery; (2) relay-inclusive D2D/SL synchronization signal (D2DSS/SLDSS) source prioritization for re-synchronization; and (3) relay-inclusive D2D/SL synchronization signal (D2DSS/SLDSS) source prioritization for initial synchronization with discovery. These situations are discussed in order below.

(1) Relay-Inclusive D2D/SL Synchronization Signal (D2DSS/SLDSS) Source Prioritization for Initial Synchronization without Discovery

It may be desirable for a network to communicate with an out-of-coverage (“remote”) wireless terminal. Such may occur for example, if the network wants to broadcast some information to all out-of-coverage wireless terminals, or to broadcast some information to wireless terminals in a group (some or all of whom may be out-of-coverage), or to unicast to some particular out-of-coverage wireless terminals. Alternatively it may be desirable for an out-of-coverage “remote” wireless terminal to communicate with the network. Such may occur, for example, if the network has configured some in coverage wireless terminals as UE-to-Network relays and the out-of-coverage wireless terminal wants to keep updated to the network via unicasting to some UE-to-Network relay wireless terminal which the remote wireless terminal discovers, or if the remote wireless terminal wants to participate in broadcasting and/or groupcasting through some potential UE-to-Network relays. But for the remote out-of-coverage wireless terminal to participate in device-to-device (D2D)/sidelink (SL) interaction through the use of UE-to-network relay (UTNR) wireless terminals, as explained above the remote out-of-coverage must first participate in initial synchronization.

Relay-inclusive D2D/SL synchronization signal (D2DSS/SLDSS) source prioritization for initial synchronization may occur either in a case of device-to-device (D2D)/sidelink (SL) communication without D2D/SL discovery or in a case of a D2D/SL discovery phase in which UTNR related information is carried by a direct discovery signal.

For relay-inclusive D2D/SL synchronization signal (D2DSS/SLDSS) source prioritization for initial synchronization in the case of device-to-device (D2D)/sidelink (SL) communication without D2D/SL discovery, the UE-to-network relay (UTNR) wireless terminal must somehow identify itself as a UNTR. That is, UE-to-network relaying information needs to be provided so that during the initial synchronization procedures, the remote wireless terminal can recognize this information so as to decide synchronization source priority. Identification of a wireless terminal as a UTNR wireless terminal is necessary if the processor 40 of the remote terminal is to successfully implement the relay-inclusive D2D/SL synchronization signal (D2DSS/SLDSS) source prioritization. That is, the processor 40 must be able to make an identification or discrimination, among the wireless terminals from which it receives synchronization information, e.g., synchronization signals, as to which one or more of the wireless terminals is/are UE-to-network relay (UTNR) wireless terminals.

In an example embodiment and mode, relay-inclusive D2D/SL synchronization signal (D2DSS/SLDSS) source prioritization processor 40 of wireless terminal 30R is configured to make a determination that a source of the synchronization information is a UE-to-network relay (UTNR) wireless terminal from content of the synchronization information.

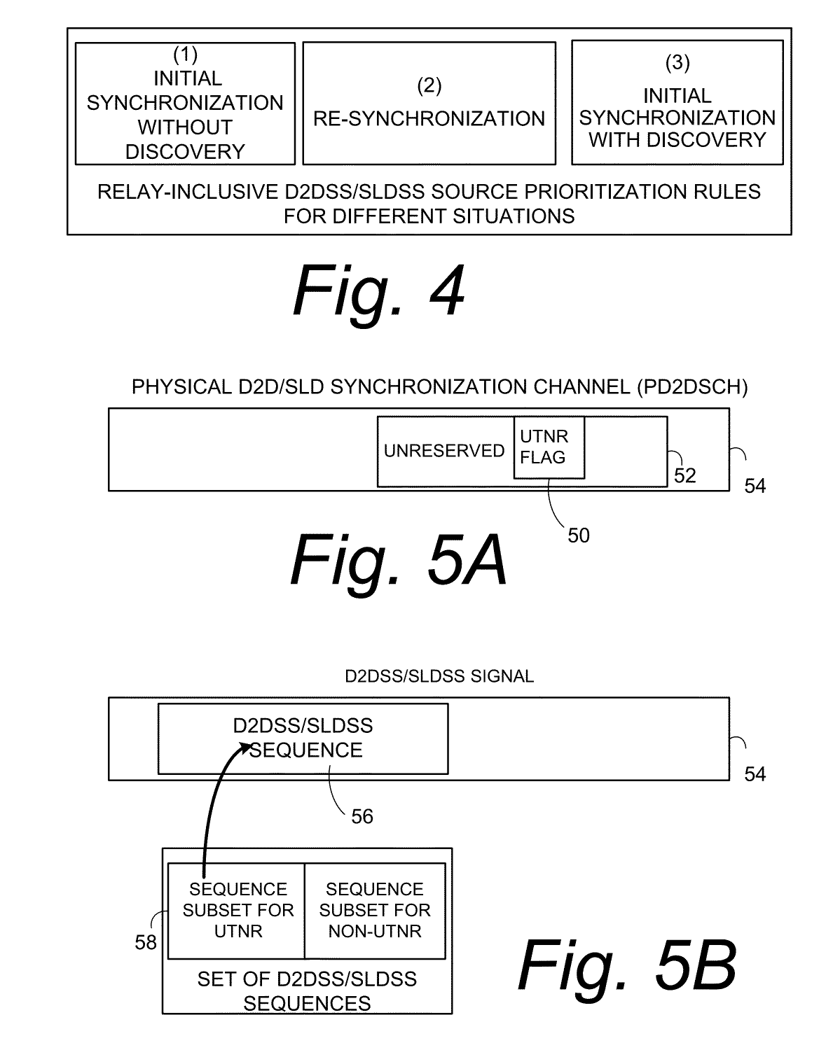

In one alternative example implementation of the content-indicative mode, the content pertinent to the determination/identification of a UE-to-network relay (UTNR) wireless terminal may comprise or be a flag in a primary D2D/SL synchronization channel. For example, as illustrated in FIG. 5A, such a flag 50 may comprise or be constituted by one UTNR-indicating bit in a reserved portion 52 of a physical D2D/SL synchronization channel (PD2DSCH) channel 54.

In another alternative example implementation of the content-indicative mode, the content pertinent to the determination/identification of a UE-to-network relay (UTNR) wireless terminal may comprise a relay-indicative sequence comprising the synchronization information, the relay-indicative sequence belonging to a relay-indicative subset of synchronization sequences. Use of synchronization sequences to express identification of a wireless terminal is described, e.g., in U.S. Provisional Patent Application 62/034,125, filed Aug. 6, 2014, entitled “SYNCHRONIZATION SIGNALS FOR DEVICE-TO-DEVICE COMMUNICATIONS”, which is incorporated herein by reference in its entirety, as well as from Table 5 hereof. For example, the synchronization information (e.g. D2D/SL synchronization signal (D2DSS/SLDSS)) may include a member of a subset of D2D/SL synchronization signal (D2DSS/SLDSS) sequences in D2DSSue_net, which subset is used to identify UTNR wireless terminals. As one non-limiting example, D2D/SL synchronization signal (D2DSS/SLDSS) sequences with D2DSS/SLDSS ID (0-83) belonging to D2DSSue_net may be allocated for UTNR wireless terminals, while on the other hand D2DSS/SLDSS sequences with D2DSS ID (84-167) belonging to D2DSSue_net may be allocated for non-UTNR wireless terminals. FIG. 5B shows, for example, a D2DSS/SLDSS sequence field 56 of D2DSS signal 54 being filled with a sequence chosen from a UTNR-indicating set of D2DSS/SLDSS sequences 58.

In an example embodiment and mode, relay-inclusive D2D/SL synchronization signal (D2DSS/SLDSS) source prioritization for initial synchronization, in the case of device-to-device (D2D)/sidelink (SL) communication without D2D/SL discovery, comprises the priority rules of Table 1, which are listed in decreasing priority rule order.

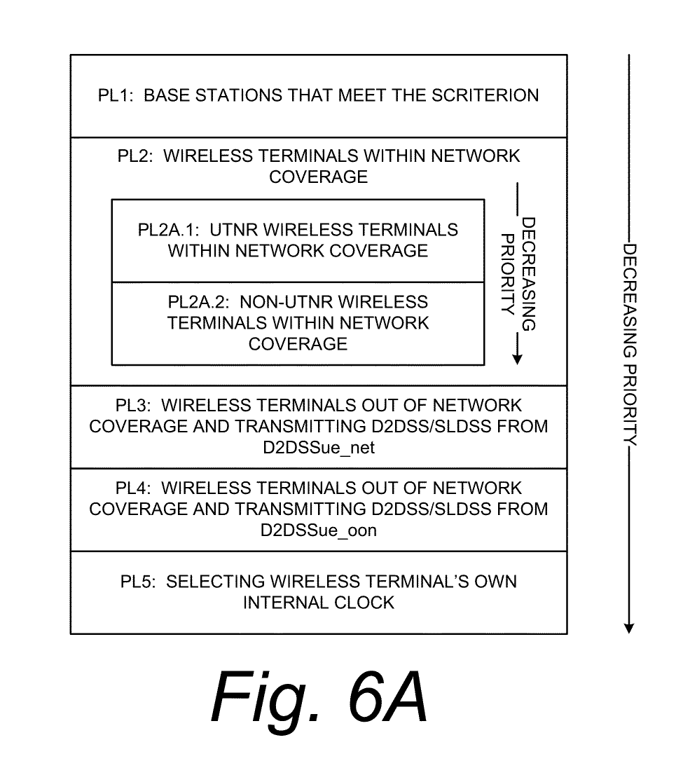

In an example general embodiment and mode, relay-inclusive D2D/SL synchronization signal (D2DSS/SLDSS) source prioritization for initial synchronization, in the case of device-to-device (D2D)/sidelink (SL) communication without D2D/SL discovery, chooses a synchronization source in accordance with the priority levels (PL) shown in FIG. 6 and also illustrated in Table 1. The priority levels are numbered as levels P1-P5, with level P1 having the highest priority, level P2 having the second highest priority, level P3 having the third highest priority, and so forth.

TABLE 1
PL1: Base stations that meet the S-criterion
PL2: wireless terminals that are within network
PL3: wireless terminals that are outside of network but which
transmit their synchronization signals (D2DSS) to include a
sequence D2DSSue_net which indicates that the timing reference is
ultimately from the network
PL4: wireless terminals that are outside of network and which
transmit their synchronization signals (D2DSS) to include a
sequence D2DSSue_oon which indicates that the timing reference is
not from the network
PL5: selecting wireless terminal's own internal clock

As shown in Table 1, the highest priority level PL1 includes base stations (e.g., eNodeBs) that meet the S-criterion. The second highest priority level PL2 includes wireless terminals that are within network coverage. The third highest priority level PL3 includes wireless terminals that are outside of network coverage but which transmit their synchronization signals (D2DSS/SLDSS) to include a sequence D2DSSue_net which indicates that the timing reference is ultimately from the network. The fourth highest priority level PL4 includes wireless terminals that are outside of network coverage but which transmit their synchronization signals (D2DSS/SLDSS) to include a sequence D2DSSue_oon which indicates that the timing reference is not from the network. The lowest (fifth) priority level L5, is the source-selecting wireless terminal's own internal clock.

FIG. 6A and FIG. 6B show differing example embodiments and modes which affect priority level PL2 for implementing relay-inclusive D2D/SL synchronization signal (D2DSS/SLDSS) source prioritization for initial synchronization, in the case of device-to-device (D2D)/sidelink (SL) communication without D2D/SL discovery, according to the technology disclosed herein.

In the embodiment of FIG. 6A, priority level PL2 has two sub-levels. The highest sub-level is level PL2A.1: UE-to-network relay (UTNR) wireless terminals within network coverage. If there are plural UE-to-network relay (UTNR) wireless terminals within network coverage, highest priority is given to the UE-to-network relay (UTNR) wireless terminal having the D2D/SL synchronization signal (D2DSS/SLDSS) received with the highest synchSourceThresh measurement. The second sub-level is level PL2A.2: Non-UE-to-network relay (UTNR) wireless terminals within network coverage. If there are plural non-UE-to-network relay (UTNR) wireless terminals within network coverage, highest priority is given to the non-UE-to-network relay (UTNR) wireless terminal having the D2D/SL synchronization signal (D2DSS/SLDSS) received with the highest synchSourceThresh measurement.

In the embodiment of FIG. 6B, there are two separate cases for priority level PL2. A first case, shown to the left of the dashed line of the block PL2, is for wireless terminals which are expecting to have communications through UE-to-network relaying. The second case, shown to the right of the dashed line of the block PL2, is for all other terminals.

In the first (left hand) case for the embodiment of FIG. 6B there are two sub-levels. The highest sub-level is level PL2BA.1: UE-to-network relay (UTNR) wireless terminals within network coverage. If there are plural UE-to-network relay (UTNR) wireless terminals within network coverage, highest priority is given to the UE-to-network relay (UTNR) wireless terminal having the D2D/SL synchronization signal (D2DSS/SLDSS) received with the highest synchSourceThresh measurement. The second sub-level is level PL2B.2: Non-UE-to-network relay (UTNR) wireless terminals within network coverage. If there are plural non-UE-to-network relay (UTNR) wireless terminals within network coverage, highest priority is given to the non-UE-to-network relay (UTNR) wireless terminal having the D2D/SL synchronization signal (D2DSS/SLDSS) received with the highest synchSourceThresh measurement.

In the second (right hand) case for the embodiment of FIG. 6B, the case for wireless terminals other than those expecting to have communications with the network through UE-to-network relaying, there is only one level, which for the second case is level PL2: wireless terminals within network coverage. If there are plural wireless terminals within network coverage, highest priority is given to the wireless terminal having the D2D/SL synchronization signal (D2DSS/SLDSS) received with the highest synchSourceThresh measurement.

The first case of the FIG. 6B embodiment applies for wireless terminals which are expecting to have communications with the network through a UE-to-network relay (UTNR) wireless terminal. The difference between the first case of FIG. 6B and the embodiment of FIG. 6A is the applicable wireless terminal range. The embodiment of FIG. 6A applies for all D2D/SL wireless terminals which require synchronizations, regardless of whether the wireless terminals expect communication through UE-to-network relaying or not. The second case of the embodiment of FIG. 6B applies when UE-to-network relaying only affects the synchronization behavior of wireless terminals when these wireless terminals need UE-to-network relaying for communications. How a wireless terminal may or will know that it needs UE-to-network relaying for D2D/SL communications is understood from the foregoing discussion of how a UE-to-network relay (UTNR) wireless terminal identifies itself as a UE-to-network relay (UTNR) wireless terminal. If the only synchronization signals received by a particular wireless terminal are those from one or more wireless terminals which identifies itself/themselves as UE-to-network relay (UTNR) wireless terminals, then the first case of FIG. 6B applies.

FIG. 6C shows an example embodiment and mode which affects priority level PL3 for implementing relay-inclusive D2D/SL synchronization signal (D2DSS/SLDSS) source prioritization for initial synchronization, in the case of device-to-device (D2D)/sidelink (SL) communication without D2D/SL discovery, according to the technology disclosed herein. In the embodiment of FIG. 6C, priority level PL3 has two sub-levels. The highest sub-level of priority level PL3 is level PL3.1: wireless terminals out of network coverage transmitting D2D/SL synchronization signal (D2DSS/SLDSS) from D2DSSue-net with information (from PD2DSCH or D2DSS sequence itself or some other ways) indicating it is a UTNR D2D/SL synchronization signal (D2DSS/SLDSS) sequence. Priority level PL3.1 is applicable provided that the remote UE which synchronizes to the UTNR D2D/SL synchronization signal (D2DSS/SLDSS) sequence transmits the same D2D/SL synchronization signal (D2DSS/SLDSS) sequence as the UTNR. If there are plural such wireless terminals out of network coverage according to this rule, highest priority is given to the wireless terminal having the D2D/SL synchronization signal (D2DSS/SLDSS) received with the highest synchSourceThresh measurement.

The second and lowest sub-level of priority level PL3 is level PL3.2: wireless terminals out of network coverage transmitting D2D/SL synchronization signal (D2DSS/SLDSS) from D2DSSue_net with information (from PD2DSCH or D2DSS sequence itself or some other ways) indicating it is not a UTNR D2D/SL synchronization signal (D2DSS/SLDSS) sequence. Priority level PL3.2 is applicable provided the remote UE which synchronizes to the UTNR D2D/SL synchronization signal (D2DSS/SLDSS) transmits the same D2D/SL synchronization signal (D2DSS/SLDSS) sequence as the UTNR. If there are plural such wireless terminals out of network coverage according to this rule, highest priority is given to the wireless terminal having the D2D/SL synchronization signal (D2DSS/SLDSS) received with the highest synchSourceThresh measurement.

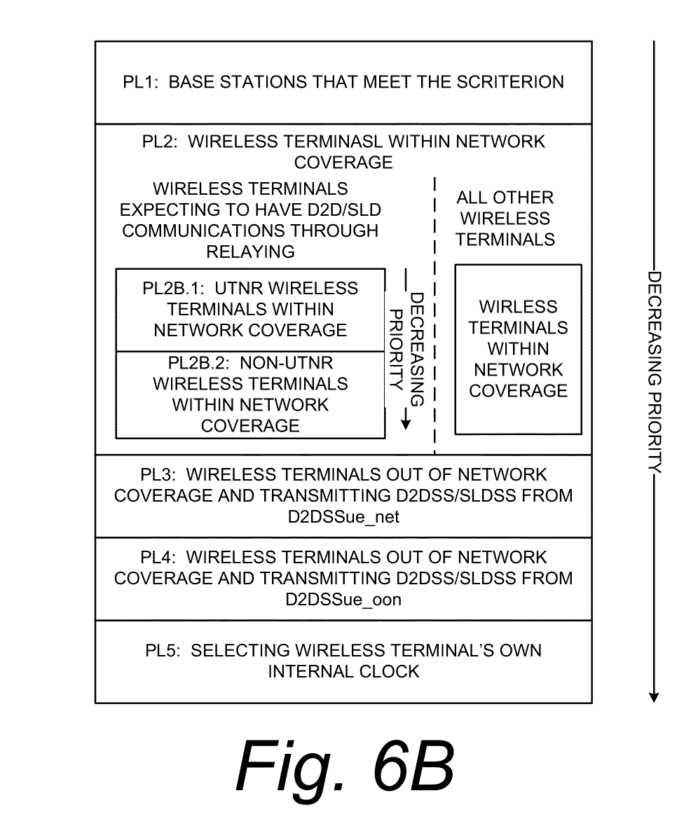

In the above regard, FIGS. 6A and 6B illustrate the scenario of FIG. 1, in which the D2D/SL synchronization signal (D2DSS/SLDSS) from wireless terminal 30₁, wireless terminal 30₂ and wireless terminal 30₃ are in priority layer PL2, with remote wireless terminal 30_{R} selecting from priority layer PL2 D2D/SL synchronization signal (D2DSS/SLDSS). FIG. 6C, on the other hand, describes another scenario, an example for which is shown in FIG. 7, in which remote wireless terminal 30_{R} synchronizes to UTNR wireless terminal 30₁, and another UE 30₄ synchronizes to wireless terminal 30₃, and both remote wireless terminal 30_{R} and wireless terminal 30₄ transmit their D2D/SL synchronization signal (D2DSS/SLDSS), which are in priority layer PL3. In the scenario of FIG. 7 further wireless terminal 30₅ receives D2DSS_{R} from remote wireless terminal 30_{R} and D2DSS₄ from wireless terminal 30₄. Wireless terminal 30₅ must then select between D2DSS_{R} and D2DSS₄. Wireless terminal 30₅ may select D2DSS_{R} from remote wireless terminal 30_{R}, in accordance with FIG. 6C; or wireless terminal 30₅ may ignore the difference between remote wireless terminal 30_{R} and wireless terminal 30₄, if no further information about UTNR is carried by remote wireless terminal 30_{R} and wireless terminal 30₄ or it is defined that the UTNR information only affects the wireless terminal directly synchronizing to it (not affecting indirect wireless terminals).

It should be understand that one or more aspects (e.g., differing priority levels/sub-levels) of the embodiments of FIG. 6A, FIG. 6B, and FIG. 6C may be combineable with one another. In fact the relay-inclusive D2D/SL synchronization signal (D2DSS/SLDSS) source prioritization processor 40 may implement relay-inclusive D2D/SL synchronization signal (D2DSS/SLDSS) source prioritization scheme that selects among the aspects of FIG. 6A, FIG. 6B, and FIG. 6C, and the cases thereof, in order to configure an appropriate, and even dynamically changeable, set of prioritization rules. In this regard, Table 2 reflects how a comprehensive scheme of prioritization rules may be configured to collectively consider the alternative aspects of FIG. 6A, FIG. 6B, and FIG. 6C.

TABLE 2
Priority Rules for Initial Synchronization without D2D/SL
Discovery

```
Priority Rule 1: eNBs that meet the S-criterion. As mentioned above,
the S-criterion (defined in 3GPP TS 36.304) refers to cell selection and
reselection signal strength/quality criteria to indicate whether the cell is
suitable for the wireless terminal.
Priority Rule 2: Priority 2 has two alternative sets of rules, e.g., rule
set 2-A.1 (from FIG. 6A) and rule set 2-A.2 (from FIG. 6B).
rule set 2-A.1: As shown in FIG. 6A, rule set 2-A.1 has two sub-rules or
  sub-layers sub-rule 2-A.1-1 (priority layer PL2A.1): UE-to-network
  relay (UTNR) wireless terminals within network coverage. If there are
  plural UE-to-network relay (UTNR) wireless terminals within network
  coverage, highest priority is given to the UE-to-network relay (UTNR)
  wireless terminal having the D2D/SL synchronization signal (D2DSS/
  SLDSS) received with the highest synchSourceThresh measurement.
  sub-rule 2-A.1-2 (priority layer PL2A.2): Non-UE-to-network relay
  (UTNR) wireless terminals within network coverage. If there are plural
  non-UE-to-network relay (UTNR) wireless terminals within network
  coverage, highest priority is given to the non-UE-to-network relay
  (UTNR) wireless terminal having the D2D/SL synchronization signal
  (D2DSS/SLDSS) received with the highest synchSourceThresh
  measurement.
rule set 2-A.2: As shown in FIG. 6B, rule set 2-A.2 has two sub-cases.
    A first subcase 2-A.2.1 (having two sub-rules) concerns wireless
    terminals which are expecting to have communications with the
    network through a UE-to-network relay (UTNR) wireless
    terminal. Such wireless terminals should monitor UTNR related
    information for further behaviors.
      sub-rule 2-A.2.1-1 (priority layer PL2B.1): UE-to-network relay
      (UTNR) wireless terminals within network coverage. If there are
      plural UE-to-network relay (UTNR) wireless terminals within
      network coverage, highest priority is given to the UE-to-network
      relay (UTNR) wireless terminal having the D2D/SL
      synchronization signal (D2DSS/SLDSS) received with the highest
      synchSourceThresh measurement.
      sub-rule 2-A.2.1-2 (priority layer PL2B.1): Non-UE-to-network
      relay (UTNR) wireless terminals within network coverage. If
      there are plural non-UE-to-network relay (UTNR) wireless
      terminals within network coverage, highest priority is given to the
      non-UE-to-network relay (UTNR) wireless terminal having the
      D2D/SL synchronization signal (D2DSS/SLDSS) received with
      the highest synchSourceThresh measurement.
    A second subcase 2-A.2.2-1 (having one sub-rule) concerns all other
    wireless terminals, e.g., wireless terminals which are not expecting to
    have communications with the network through a UE-to-network relay
    (UTNR) wireless terminal.
      sub-rule 2-A.2.1-1: wireless terminals within network coverage.
      If there are plural wireless terminals within network coverage,
      highest priority is given to the wireless terminal having the
      D2D/SL synchronization signal (D2DSS/SLDSS) received with
      the highest synchSourceThresh measurement.
Priority Rule 3: Priority 3 has two alternative sets of rules, e.g., rule
set 3-A.1 and rule set 3-A.2 (from FIG. 6C).
rule set 3-A.1 (one rule):
  3-A.1-1: wireless terminals out of network coverage transmitting D2D/
  SL synchronization signal (D2DSS/SLDSS) from D2DSSue-net. If
  there are plural such wireless terminals out of network coverage, highest
  priority is given to the wireless terminal having the D2D/SL
  synchronization signal (D2DSS/SLDSS) received with the highest
  synchSourceThresh measurement.
rule set 3-A.2 two rules):
  3-A.2-1 (priority level PL3.1 of FIG. 6C): wireless terminals out of
  network coverage transmitting D2D/SL synchronization signal
  (D2DSS/SLDSS) from D2DSSue-net with information (from
  PD2DSCH or D2DSS sequence itself or some other ways) indicating
  it is a UTNR D2DSS sequence, provided that the remote UE
  which synchronizes to the UTNR D2D/SL synchronization signal
  (D2DSS/SLDSS) sequence transmits the same D2D/SL
  synchronization signal (D2DSS/SLDSS) sequence as the UTNR.
  If there are plural such wireless terminals out of network coverage
  according to this rule, highest priority is given to the wireless
  terminal having the D2D/SL synchronization signal (D2DSS/
  SLDSS) received with the highest synchSourceThresh
  measurement.
  3-A.2-2 (priority level PL3.2 of FIG. 6C): wireless terminals out
  of network coverage transmitting D2D/SL synchronization signal
  (D2DSS/SLDSS) from D2DSSue-net with information (from
  PD2DSCH or D2DSS sequence itself or some other ways)
  indicating it is not a UTNR D2D/SL synchronization signal
  (D2DSS/SLDSS) sequence, provided that the remote UE which
  synchronizes to the UTNR D2D/SL synchronization signal
  (D2DSS/SLDSS) sequence transmits the same D2D/SL
  synchronization signal (D2DSS/SLDSS) sequence as the UTNR.
  If there are plural such wireless terminals out of network
  coverage according to this rule, highest priority is given to the
  wireless terminal having the D2D/SL synchronization signal
  (D2DSS/SLDSS) received with the highest
  synchSourceThresh measurement.
Priority Rule 4: wireless terminals out of network coverage
transmitting D2D/SL synchronization signal (D2DSS/SLDSS)
from D2DSSue_oon. If there are plural such wireless terminals
out of network coverage according to this rule, highest priority
is given to the wireless terminal having the D2D/SL
synchronization signal (D2DSS/SLDSS) received with the
highest synchSourceThresh measurement.
Priority Rule 5: If none of the foregoing Priority Rules 1-4
apply, as Priority Rule 5 the wireless terminal uses its own
internal clock for synchronization.
```

(2) Relay-Inclusive D2D/SL Synchronization Signal (D2DSS/SLDSS) Source Prioritization for Re-Synchronization

As mentioned above, re-synchronization occurs after a wireless terminal has already been initially synchronized to some base station or cluster head wireless terminal. Now described is a situation in which UE-to-network relaying impact is only considered during re-synchronization, so there is no impact on the initial synchronization. Having already had at least initial synchronization, a re-synchronizing a remote wireless terminal such as wireless terminal 30R can read information and thus can know whether there is UE-to-network relaying nearby. A wireless terminal 30R may want to re-synchronization (e.g., re-synchronization may be triggered) for various reasons after initial synchronization, such as upon detecting or discovering the existence of a proper UE-to-network relay (UTNR) in the vicinity of the wireless terminal 30R and determining whether it should synchronization to such UE-to-network relay (UTNR). For some reasons (e.g., after detecting proper UE-to-network relaying in the proximity) a resynchronization may be triggered, the UE can decide whether it should synchronize to the UE-to-network relaying.

In accordance with an example embodiment, the relay-inclusive D2D/SL synchronization signal (D2DSS/SLDSS) source prioritization processor 40 of wireless terminal 30_{R} may implement a relay-inclusive D2D/SL synchronization signal (D2DSS/SLDSS) source prioritization in a re-synchronization mode/procedure (e.g., after there has already been initial synchronization for the wireless terminal 30_{R}). Implementing a relay-inclusive D2D/SL synchronization signal (D2DSS/SLDSS) source prioritization in a re-synchronization mode/procedure may be dependent on fulfillment of two conditions: (1) UE-to-Network relaying is configured or has been triggered to participate in ProSe services, e.g., D2D/SL relay communications, and (2) a pairing of wireless terminal 30R and a UE-to-Network relay has been determined.

The UE-to-Network relaying may be configured by the network, or the UTNR wireless terminal itself detects an out of coverage UE and is triggered by this detection event and sends a message to a eNB 22 requesting to be a UTNR wireless terminal. Alternatively, an out-of-coverage wireless terminal may detect an in coverage wireless terminal in its proximity and may send a message to the in-coverage wireless terminal, thereby triggering the in-coverage wireless terminal to send a message to the eNB 22 requesting for the in-coverage wireless terminal to be configured as a UTNR wireless terminal. Configuration may also occur in other ways.

The paring of wireless terminal 30R and a UE-to-Network relay may be determined either by the network or by the wireless terminal 30_{R} (e.g., the wireless terminal 30_{R} has discovered UE-to-Network relays in its proximity and has selected one as its relaying).

In implement a relay-inclusive D2D/SL synchronization signal (D2DSS/SLDSS) source prioritization in a re-synchronization mode/procedure, in its synchronization source selection the processor 40 uses the prioritization scheme of Table 1 but with the further constraint of selecting the UE-to-Network relay wireless terminal (with which it has already been paired) as having the highest priority among UE D2D/SL synchronization signal (D2DSS/SLDSS) sources for its wireless terminal 30R. This assumes, of course, that the wireless terminal 30R is out of coverage, and that there is no base station (BS, e.g., no eNodeB, that can meet the S-criterion). Thus, upon such selection the wireless terminal 30R is triggered to resynchronize to the UE-to-Network relay wireless terminal if it has not already done so.

Following re-synchronization, if the wireless terminal 30R, or the monitoring UE in discovery Model A, or the in discovery Model B, needs to transmit D2D/SL synchronization signal (D2DSS/SLDSS), it uses the UE-to-Network's timing as its transmit timing reference, and transmits the same D2D/SL synchronization signal (D2DSS/SLDSS) sequence as does the UE-to-Network relay to which it is paired. As explained, e.g., in 3GPP TS23.202 V12.2.0, ProSe Direct discovery following Model A or Model B can be used in order to allow the remote wireless terminal to discover a ProSe UE-to-Network Relay(s) in proximity.

(3) Relay-Inclusive D2D/SL Synchronization Signal (D2DSS/SLDSS) Source Prioritization for Initial Synchronization with Discovery

Already described above was a relay-inclusive D2D/SL synchronization signal (D2DSS/SLDSS) source prioritization for initial synchronization which occurs in a case of device-to-device (D2D)/sidelink (SL) communication without D2D/SL discovery. Relay-inclusive D2D/SL synchronization signal (D2DSS/SLDSS) source prioritization for initial synchronization which occurs in a D2D/SL discovery phase in which UTNR related information is carried by a direct discovery signal is described below.

In the above regard, in some situations the network has to first discover/identify out-of-coverage wireless terminals. After such discovery and identification the device-to-device (D2D)/sidelink (SL) interaction using relays (UE-to-network relay (UTNR) wireless terminals) can be operated. In such situations the remote wireless terminal synchronization can be done in the phase of direct discovery. Heretofore there has been no discovery-specific D2D/SL synchronization signal (D2DSS/SLDSS) defined, which means that heretofore a remote wireless terminal could not tell from the D2D/SL synchronization signal (D2DSS/SLDSS) signal itself whether the D2DS signal is employed for discovery service or for communication service.

In an example embodiment and mode, the processor 40 of the wireless terminal 30_{R} is able to perform relay-inclusive D2D/SL synchronization signal (D2DSS/SLDSS) source prioritization in view of the fact that, according to an aspect of the technology disclosed herein, UTNR related information is carried by a direct discovery signal which is transmitted from a UE-to-network relay (UTNR) wireless terminal. A discovery signal includes its own D2D/SL synchronization signal, e.g., the D2D/SL synchronization signal (D2DSS/SLDSS) of the discovery signal.

Currently there are two models for Proximity Services (ProSe) Direct Discovery: Model A and Model B. Both Model A and Model B involve direct discovery signals, as explained below.

Model A defines two roles for the ProSe-enabled wireless terminals that are participating in ProSe Direct Discovery: an announcing wireless terminal (e.g., announcing UE) and a monitoring wireless terminal (e.g., monitoring UE). The announcing wireless terminal sends an announcing direct discovery signal that announces certain information that could be used by other wireless terminals in proximity that have permission to participate in discovery. The monitoring wireless terminal receives the announcing direct discovery signal and monitors certain information of interest in proximity of announcing wireless terminals. Thus, in Model A an announcing wireless terminal broadcasts discovery messages, e.g., direct discovery signals, at pre-defined discovery intervals, and the monitoring wireless terminals that are interested in these messages read the messages and process the messages. In accordance with the technology disclosed herein, for Model A the announcing direct discovery signal may be formatted or configured to carry an indication that the announcing wireless terminal is a UE-to-network relay (UTNR) wireless terminal. For example, indication that the announcing wireless terminal is a UE-to-network relay (UTNR) wireless terminal may be or comprise a bit flag or sequence in the announcing direct discovery signal which indicates that the announcing wireless terminal is a UE-to-network relay (UTNR) wireless terminal.

Model B also defines defines two roles for the ProSe-enabled wireless terminals that are participating in ProSe Direct Discovery: a discoverer wireless terminal (e.g., discoverer UE) and a discoveree wireless terminal (e.g., discoveree UE). The discoverer wireless terminal transmits a request (e.g., a request direct discovery signal) containing certain information about what it is interested to discover. For example, the discoverer wireless terminal may transmit a direct discovery signal inquiring “who is there?” or “are you there?” The discoveree wireless terminal that receives the request message can respond (using, e.g., a response direct discovery signal) with some information related to the discoverer's request. In terms of the technology described herein, the discoverer wireless terminal may transmit a request or inquiry direct discovery signal which inquires “is there a UTNR wireless terminal out there?” The discoveree wireless terminal, if it is a UNTR wireless terminal, may respond with a response direct discovery signal which states “I am a UNTR wireless terminal”. Thus, in accordance with the technology disclosed herein, for Model B the response direct discovery signal may be formatted or configured to carry an indication that the discoveree wireless terminal is a UE-to-network relay (UTNR) wireless terminal. For example, indication that the discoveree wireless terminal is a UE-to-network relay (UTNR) wireless terminal may be or comprise a bit flag or sequence in the response direct discovery signal which indicates that the discoveree wireless terminal is a UE-to-network relay (UTNR) wireless terminal.

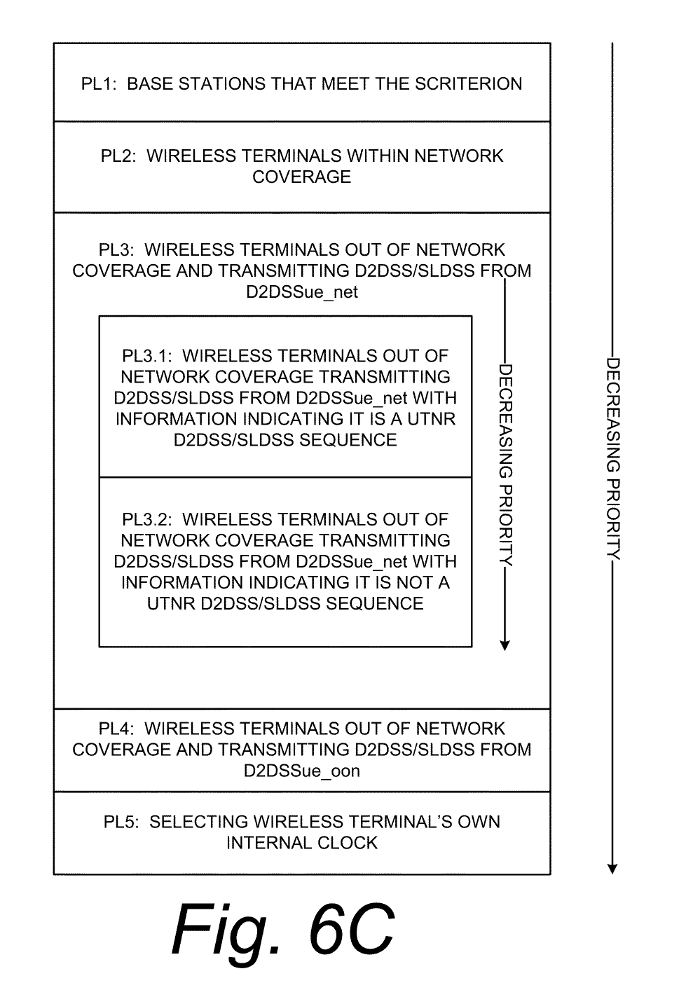

In accordance with an example embodiment and mode, as shown in FIG. 8, a UE-to-network relay (UTNR) wireless terminal 30_{UTNR} is configured to transmit with its discovery signal an indication whether the wireless terminal can serve as a UE-to-network relay (UTNR) wireless terminal. In particular FIG. 8 shows UE-to-network relay (UTNR) wireless terminal 30_{UTNR} as comprising D2D/SL controller 60 which includes D2D/SL discovery processor 62. The D2D/SL discovery processor 62 is shown as generating discovery signal 64. The UE-to-network relay (UTNR) wireless terminal 30_{UTNR} may be either a Model A announcing wireless terminal (in which case the generated discovery signal 64 may be an announcing direct discovery signal) or a Model B discoveree wireless terminal (in which case the generated discovery signal 64 may be a response direct discovery signal).

The discovery signal 64 comprises an indication that the wireless terminal is a UTNR wireless terminal, e.g., the discovery signal 64 includes UTNR indication 66. As explained above, the fact that the wireless terminal is a UE-to-network relay (UTNR) wireless terminal (and thus the UTNR indication 66) may be manifest by the fact that the discovery signal 64 carries a UTNR-indicative flag (such as flag 50 illustrated in FIG. 5A), or by inclusion of an UTNR-indicative D2D/SL synchronization signal (D2DSS/SLDSS) sequence (as shown in FIG. 5B).

In view of the fact that a wireless terminal such as wireless terminal 30_{UTNR} includes in its discovery signal an indication that the wireless terminal a UE-to-network relay (UTNR) wireless terminal, the relay-inclusive D2D/SL synchronization signal (D2DSS/SLDSS) source prioritization processor 40 of the remote wireless terminal 30_{R} can recognize during discovery phase that there is a UE-to-network relay (UTNR) wireless terminal in its vicinity and can implement the relay-inclusive D2D/SL synchronization signal (D2DSS/SLDSS) source prioritization described herein. That is, the processor 40 may determine that at least one of plural candidate synchronization sources is a UE-to-network relay (UTNR) wireless terminal by detecting an indication (e.g., UTNR indication 66) in discovery signal 64 from the at least one candidate synchronization source that the at least one candidate synchronization source is a UE-to-network relay (UTNR) wireless terminal. The processor 40 may then implement the relay-inclusive D2D/SL synchronization signal (D2DSS/SLDSS) source prioritization, for example the prioritizations as described herein for either the initial synchronization procedure/situations (e.g., FIG. 6A, FIG. 6B, or FIG. 6C) or for the re-synchronization situation/procedure.

If, in the situation of FIG. 8, the remote wireless terminal 30_{R} needs to transmit D2D/SL synchronization signal (D2DSS/SLDSS), as a result of its selection of wireless terminal 30_{UTNR} as its synchronization source the remote wireless terminal 30_{R} uses the UE-to-Network's timing as its transmit timing reference when transmitting, and transmits the same D2D/SL synchronization signal (D2DSS/SLDSS) sequence as the UE-to-Network relay 30_{UTNR}.

In the coverage discovery scenario that predates the technology disclosed herein, no PD2DSCH is associated with the discovery signal D2D/SL synchronization signal (D2DSS/SLDSS). As a result, an “IC_Indicator” cannot be obtained. But the remote wireless terminal needs to know whether the candidate synchronization source is in-coverage or out-of-coverage before the relay-inclusive D2D/SL synchronization signal (D2DSS/SLDSS) source prioritization rules of either FIG. 6A or FIG. 6B can be used. In contrast, in the future PD2DSCH may be allowed to be associated with discovery D2D/SL synchronization signal (D2DSS/SLDSS) for partial and out of coverage scenarios, and such inclusion of PD2DSCH (and in particular the “IC_Indicator” in PD2DSCH) will provide the required in-coverage or out-of-coverage indication. But in other situations including those in which PD2DSCH is not associated with discovery D2D/SL synchronization signal (D2DSS/SLDSS), the in-coverage or out-of-coverage indication may be carried by some other ways. For example, the direct discovery signal 64 may itself comprise a one bit similar to that of “IC_Indicator”. If it turns out that in-coverage or out-of-coverage indication cannot be obtained, then the remote UE should synchronize to the discovery D2D/SL synchronization signal (D2DSS/SLDSS) transmitted by the UTNR which has already been determined as a relay for the remote wireless terminal.

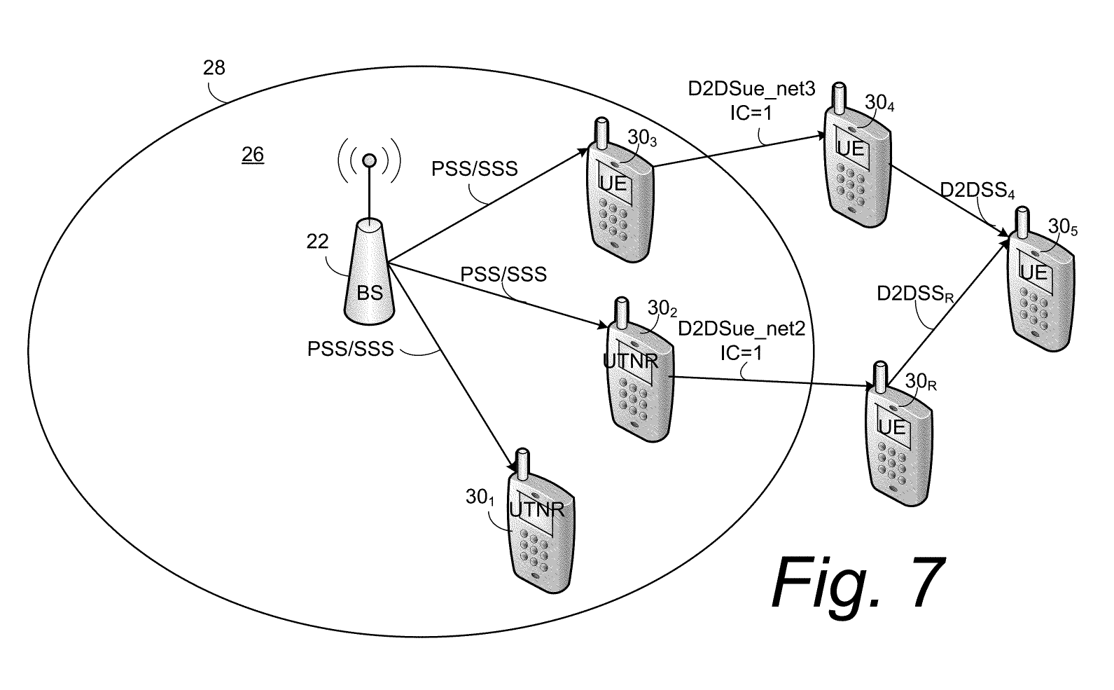

In view of the foregoing, FIG. 9 shows basic, representative acts or steps of a method of operating a wireless terminal which operates at least partially in a D2D/SL discovery phase. Act 9-1 comprises transmitting a discovery signal over a radio interface. Act 9-2 comprises including in the discovery signal an indication that the wireless terminal is a UE-to-network relay (UTNR) wireless terminal. Optional act 9-3 comprises including in the discovery signal an indication of whether the wireless terminal is in network coverage or out of network coverage.

Thus, the technology disclosed herein provides solutions for D2D/SL synchronization source selection in, e.g., a partial coverage scenario when the UE-to-Network relaying feature is introduced. Among other things, the technology disclosed herein advantageously:
prioritizes selection of a UE-to-Network synchronization source so as to maintain proper D2D/SL unicast communication and D2D/SL relay communication.
Is flexibly implemented depending on whether resynchronization procedures triggered by introducing UE-to-Network is needed.
minimizes the impact on the current 3GPP agreements.

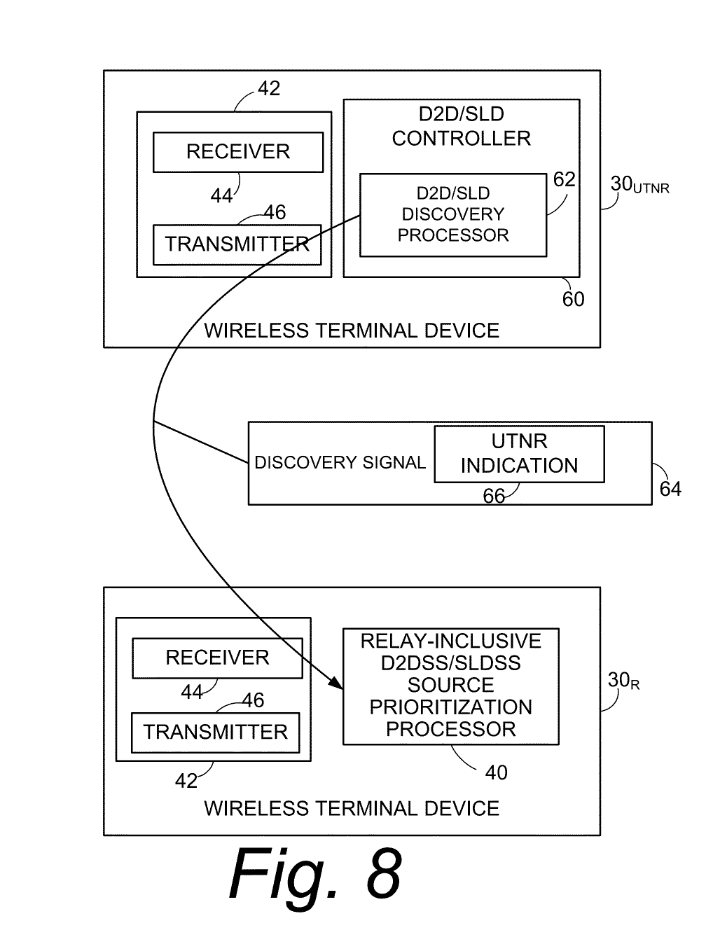

The relay-inclusive D2D/SL synchronization signal (D2DSS/SLDSS) source prioritization processor 40 of the wireless terminals encompassed hereby, and the D2D/SL controller 60 of a UE-to-network relay (UTNR) wireless terminal 30UTNR of FIG. 8, are preferably realized by electronic circuitry 80 which may include a computer processor, as shown in FIG. 10. It will also be appreciated that each wireless terminal 30 includes other unillustrated functionalities and units pertinent to the operation of wireless terminal 30, and that one or more of those unillustrated functionalities and units may also be realized by electronic circuitry 80. The electronic circuitry 80 may comprise one or more processors 90, program instruction memory 92; other memory 94 (e.g., RAM, cache, etc.); input/output interfaces 96; peripheral interfaces 98; support circuits 99; and busses 100 for communication between the aforementioned units. The memory 94, or computer-readable medium, may be one or more of readily available memory such as random access memory (RAM), read only memory (ROM), floppy disk, hard disk, flash memory or any other form of digital storage, local or remote, and is preferably of non-volatile nature. The support circuits 99 are coupled to the processors 90 for supporting the processor in a conventional manner. These circuits include cache, power supplies, clock circuits, input/output circuitry and subsystems, and the like.

Those skilled in the art will appreciate that the functions described may be implemented in one or more nodes using optical components, electronic components, hardware circuitry (e.g., analog and/or discrete logic gates interconnected to perform a specialized function, ASICs, PLAs, etc.), and/or using software programs and data in conjunction with one or more digital microprocessors or general purpose computers. Moreover, certain aspects of the technology may additionally be considered to be embodied entirely within any form of non-transient computer-readable memory, such as, for example, solid-state memory, magnetic disk, optical disk, etc., containing an appropriate set of computer instructions that may be executed by a processor to carry out the techniques described herein.

The term “electrical signal” is used herein to encompass any signal that transfers information from one position or region to another in an electrical, electronic, electromagnetic, optical, or magnetic form. Electrical signals may be conducted from one position or region to another by electrical, optical, or magnetic conductors including via waveguides, but the broad scope of electrical signals also includes light and other electromagnetic forms of signals (e.g., infrared, radio, etc.) and other signals transferred through non-conductive regions due to electrical, electronic, electromagnetic, or magnetic effects, e.g., wirelessly. In general, the broad category of electrical signals includes both analog and digital signals and both wired and wireless mediums. An analog electrical signal includes information in the form of a continuously variable physical quantity, such as voltage; a digital electrical signal, in contrast, includes information in the form of discrete values of a physical characteristic, which could also be, for example, voltage.

Moreover, each functional block or various features of the base station device and the terminal device (the video decoder and the video encoder) used in each of the aforementioned embodiments may be implemented or executed by a circuitry, which is typically an integrated circuit or a plurality of integrated circuits. The circuitry designed to execute the functions described in the present specification may comprise a general-purpose processor, a digital signal processor (DSP), an application specific or general application integrated circuit (ASIC), a field programmable gate array (FPGA), or other programmable logic devices, discrete gates or transistor logic, or a discrete hardware component, or a combination thereof. The general-purpose processor may be a microprocessor, or alternatively, the processor may be a conventional processor, a controller, a microcontroller or a state machine. The general-purpose processor or each circuit described above may be configured by a digital circuit or may be configured by an analogue circuit. Further, when a technology of making into an integrated circuit superseding integrated circuits at the present time appears due to advancement of a semiconductor technology, the integrated circuit by this technology is also able to be used.

Unless the context indicates otherwise, the terms “circuitry” and “circuit” refer to structures in which one or more electronic components have sufficient electrical connections to operate together or in a related manner. In some instances, an item of circuitry can include more than one circuit. A “processor” is a collection of electrical circuits that may be termed as a processing circuit or processing circuitry and may sometimes include hardware and software components. In this context, software refers to stored or transmitted data that controls operation of the processor or that is accessed by the processor while operating, and hardware refers to components that store, transmit, and operate on the data. The distinction between software and hardware is not always clear-cut, however, because some components share characteristics of both. A given processor-implemented software component can often be replaced by an equivalent hardware component without significantly changing operation of circuitry, and a given hardware component can similarly be replaced by equivalent processor operations controlled by software.

Hardware implementations of certain aspects may include or encompass, without limitation, digital signal processor (DSP) hardware, a reduced instruction set processor, hardware (e.g., digital or analog) circuitry including but not limited to application specific integrated circuit(s) (ASIC) and/or field programmable gate array(s) (FPGA(s)), and (where appropriate) state machines capable of performing such functions.

Circuitry can be described structurally based on its configured operation or other characteristics. For example, circuitry that is configured to perform control operations is sometimes referred to herein as control circuitry and circuitry that is configured to perform processing operations is sometimes referred to herein as processing circuitry.

In terms of computer implementation, a computer is generally understood to comprise one or more processors or one or more controllers, and the terms computer, processor, and controller may be employed interchangeably. When provided by a computer, processor, or controller, the functions may be provided by a single dedicated computer or processor or controller, by a single shared computer or processor or controller, or by a plurality of individual computers or processors or controllers, some of which may be shared or distributed.

Nodes that communicate using the air interface also have suitable radio communications circuitry. Moreover, the technology can additionally be considered to be embodied entirely within any form of computer-readable memory, such as solid-state memory, magnetic disk, or optical disk containing an appropriate set of computer instructions that would cause a processor to carry out the techniques described herein.

Some the terminology employed for concepts as described herein has been updated or changed in more recent industry documentation, such as the 3GPP Technical Standards, for example. As mentioned above, “device-to-device (D2D)” is now also called “sidelink direct” or “sidelink”. Some other terminology has also changed, a partial listing appearing in Table 4.

TABLE 4
Terminology

| Previous Terminology | New Terminology |
|---|---|
| Schedule assignment SA | PSCCH Physical Sidelink Control |
| | Channel |
| PD2DSCH (Phys. D2D Synch. | PSBCH (Phys. Sidelink Broadcast |
| Channel) | Channel) |
| D2DSS (D2D synchronization | SLSS (Sidelink Synchronization |
| signals) | Signals) |
| D2D Communications or Data | PSSCH (Physical Sidelink Shared |
| Channel | Channel) |
| D2D Discovery Channel | DSDCH |

The following Tables 5-9 are also incorporated by reference herein and included in this disclosure:

TABLE 5
D2DSS and PD2DSCH (FROM 3GPP RAN1 #79)
D2DSS AND PD2DSCH INFORMATION

| | |
|---|---|
| • | PD2DSS symbols are adjacent |

| | |
|---|---|
| - | No changes in signal design |

| | |
|---|---|
| • | SD2DSS symbols are adjacent |
| • | Antenna port X (where X is a new AP defined by the spec |

editor) is used for transmission of PD2DSS, SD2DSS

| | |
|---|---|
| - | At least for synchronisation resources that are not |

used for both communication and discovery, in-
coverage UEs may assume the same Doppler shift/spread
for the DMRS (for PD2DSCH) and PD2DSS within the same
synchronization resource

| | |
|---|---|
| • | Exact wording for specification is up to the |

Editor(s)

| | |
|---|---|
| - | Note that from the receiving UE's perspective, the |

composite received signal may come from different UEs

| | |
|---|---|
| • | How/if this needs to be captured in the |

specification is to be proposed by the Editor(s)

| | |
|---|---|
| • | Normal CP symbol locations: |

| | |
|---|---|
| - | PD2DSS: l = 1 and 2 in the first slot |
| - | SD2DSS: l = 4 and 5 in the second slot |

| | |
|---|---|
| • | Extended CP symbol locations: |

| | |
|---|---|
| - | PD2DSS: l = 0 and 1 in the first slot |
| - | SD2DSS: l = 3 and 4 in the second slot |

PD2DSCH contents:

| | |
|---|---|
| • | DFN: 14 bits = 10 bits counter + 4 bits offset |
| • | TDD UL-DL config: 3 bits: |

| ∘ | In case of FDD, this field is set to 000, purely for |
|---|---|
| | the purpose of decoding of PD2DSCH and does not imply |
| | any other UE behaviour |
| ∘ | The UE is assumed to know a priori the duplex mode of |

the carrier

| • | In-coverage indicator: 1 bit |
|---|---|
| • | Sidelink system bandwidth: 3 bits |
| • | Reserved field: 20 bits set to a SIB-signalled or |
| | preconfigured value in Rel-12 |
| • | Inform RAN2 about the above content for PD2DSCH - include |
| | in LS to RAN2 and RRC spreadsheet. |
| • | Indicate to RAN2 that the resource pool preconfiguration |

can be per value of system bandwidth.

| | | | | | DMRS base sequence | | | | | |
|---|---|---|---|---|---|---|---|---|---|---|
| | Scrambling | | | | | | Delta | | DMRS | |
| | Cell ID | RNTI | Slot | Code | Group | Sequence | shift | Cell ID | CS | OCC |
| PD2DSCH | D2DSS ID | Fixed | Fixed | 0 | Disabled | Disabled | 0 | D2DSS ID | D2DSS ID | D2DSS ID |
| | (0-335) | to 0 | to 0 | | | | | bits 4-9 | bits 1-3 | bit 0 |

| | |
|---|---|
| • | D2DSS ID in D2DSSue_net has range {0-167} |
| • | D2DSS ID in D2DSSue_oon has range {168-335} |
| • | PSSID is the same as D2DSS ID |
| • | Note that the index in the agreement where the index of |

the D2DSS sequence in D2DSSue_oon is the same as the index
of the D2DSS sequence in D2DSSue_net assumes that the
index is relative to the start of the range of the
respective set of sequences.

1 bit is included in PD2DSCH to indicate whether a UE is in
coverage or not.

| | |
|---|---|
| ∘ | Set to 1 if the UE is in coverage |
| ∘ | Set to 0 if the UE is out of coverage |

TABLE 6
D2DSS SEQUENCE SELECTION (FROM 3GPP RAN1 #79)

```
In-coverage UE:
  If a UE is transmitting D2DSS/PD2DSCH
    If the UE is camping/connected to an eNB
      The D2DSS sequences and PD2DSCH contents are
      signalled by the eNB and no content is obtained
      from the pre-configuration
        DFN: same as SFN + subframe number in which
        the PD2DSCH is transmitted
        In-coverage indicator: 1
        Reserved field: from SIB
      D2DSS belongs to D2DSSue_net
Partial Coverage
  If a UE is transmitting D2DSS/PD2DSCH
    If the UE selects D2DSS/PD2DSCH from in-coverage UEs
    as its transmission timing reference and D2DSS
    belongs to D2DSSue_net (and thus the UE is not
    camping/connected to an eNB)
      The D2DSS sequences and PD2DSCH contents are the
      same as the received D2DSS/PD2DSCH and not the
      pre-configuration, except for:
        DFN: subframe in which the PD2DSCH is
        transmitted
        In-coverage indicator: 0
Out of coverage case 1
  If a UE is transmitting D2DSS/PD2DSCH
    If the UE selects D2DSS/PD2DSCH from out-of-coverage
    UEs as its transmission timing reference and D2DSS
    belongs to D2DSSue_net (and thus the UE is not
    camping/connected to an eNB)
      The PD2DSCH contents are the same as the
      received PD2DSCH, except for:
        DFN: subframe in which the PD2DSCH is
        transmitted
      D2DSS is the sequence in D2DSSue_oon that has
      the same index as the received sequence in
      D2DSSue_net
Out of coverage case 2
  If a UE is transmitting D2DSS/PD2DSCH
    If the UE selects D2DSS/PD2DSCH from out-of-coverage
    UEs as its transmission timing reference and D2DSS
    belongs to D2DSSue_oon (and thus the UE is not
    camping/connected to an eNB)
      The D2DSS sequence is the same as the received
      D2DSS
      PD2DSCH contents are the same as the received
      PD2DSCH, except for:
        DFN: subframe in which the PD2DSCH is
        transmitted
Out of coverage case 3:
  If a UE is transmitting D2DSS/PD2DSCH
    If the UE does not select any D2DSS/PD2DSCH as its
    transmission timing reference and it is not
    camping/connected to an eNB
      The PD2DSCH contents are determined by the pre-
      configuration, except for
        In-coverage indicator: 0
        DFN: using preconfigured value of
        syncOffsetIndicator, with the rest of the
        DFN being up to UE implementation for the
        first transmission
      D2DSS sequence is arbitrarily selected from
      D2DSSue_oon, and can only be reselected if there
      is a change of transmission timing reference
```

TABLE 7
3GPP TR 36.843 (VER 12.0.1)

```
7.2.2 Selection of timing reference D2D
Synchronization Source
Working assumption: If a UE transmits a D2D signal, the rules
for determining which D2D Synchronization Source the UE uses
as the timing reference for its transmissions of D2D signal are
  D2D Synchronization Sources which are eNodeBs have a higher
  priority than D2D Synchronization Sources which are UEs;
  D2D Synchronization Sources which are UEs in-coverage have
  a higher priority than D2D Synchronization Sources which are
  UEs out-of-coverage;
  After giving priority to D2D Synchronization Sources which
  are eNodeBs, followed by UEs in-coverage, selection of D2D
  Synchronization Source is based on at least the following
  metrics:
      Received D2DSS quality:
        For example, a UE selects a D2DSS with a better
        received signal quality when all the other metrics are
        the same.
        FFS whether to define the measurement for received
        D2DSS quality.
      FFS Stratum level: A UE selects a D2DSS with a smaller
      stratum level when all the other metrics are the same.
  FFS on further detailed D2D Synchronization Source selection
  criterion.
  FFS on how D2D Synchronization Source type and stratum
  level can be carried by D2DSS/PD2DSCH.
    For out-of-coverage
        A UE can become a D2D Synchronization Source if
        received signal strength of all received D2DSS(s) by
        the UE are below X dBm
          FFS on details of how to compute the received
          signal strength of a D2DSS
          FFS for how long the received signal strength
          has to be below X dBm
          The value of X dBm is pre-configured
          The value of X can be infinite, i.e., every UE
          can become a D2D Synchronization Source
          Set of other possible values of X is FFS
        Other criteria under which a UE may become a D2D
        synchronization source are not precluded-FFS
        Any possible conditions under which a UE shall not
        become or shall cease to be a D2D synchronisation
        source are FFS
    For in-coverage
        A UE can become a D2D Synchronization Source at
        least if it is configured to do so by the eNB
          FFS whether any additional criteria have to be
          met before a UE that is configured to become a
          D2D synchronization source can become one.
          FFS whether any special UE reporting is needed
          to assist the eNB
        FFS for other criteria, e.g. if the eNB has
        configured resources within which D2DSS may be
        transmitted
          Consider interference impact to cellular in such
          cases.
        FFS whether UEs in coverage have to be RRC
        connected in order to transmit D2DSS
        Any possible conditions under which a UE shall not
        become or shall cease to be a D2D synchronization
        source are FFS
```

TABLE 8
Synchronization (from 3GPP TS36.211)

6.11 Synchronization signals
There are 504 unique physical-layer cell identities. The physical-layer
cell identities are grouped into 168 unique physical-layer cell-identity
groups, each group containing three unique identities. The grouping is
such that each physical-layer cell identity is part of one and only one
physical-layer cell-identity group. A physical-layer cell identity
N_{ID}^{cell} = 3N_{ID}⁽¹⁾ + N_{ID}⁽²⁾ is thus uniquely defined by a number N_{ID}⁽¹⁾
in the range of 0 to 167, representing the physical-layer cell-identity
group, and a number N_{ID}⁽²⁾ in the range of 0 to 2, representing the
physical-layer identity within the physical-layer cell-identity group.
6.11.1 Primary synchronization signal
6.11.1.1 Sequence generation
The sequence d(n) used for the primary synchronization signal is
generated from a frequency-domain Zadoff-Chu sequence
according to
${d}_{u} ( n ) = \{ \begin{matrix}{e}^{- j \frac{π un ( n + 1 )}{63}} & n = 0 , 1 , … , 30 \\ {e}^{- 1 \frac{π u ( n + 1 ) ( n + 2 )}{63}} & n = 31 , 32 , … , 61\end{matrix}$
where the Zadoff-Chu root sequence index u is given by Table
6.11.1.1-1.
Table 6.11.1.1-1: Root indices for the primary synchronization signal

| N_{ID}⁽²⁾ | Root index u |
|---|---|
| 0 | 25 |
| 1 | 29 |
| 2 | 34 |

6.11.1.2 Mapping to resource elements
The mapping of the sequence to resource elements depends on the
frame structure. The UE shall not assume that the primary
synchronization signal is transmitted on the same antenna port
as any of the downlink reference signals. The UE shall not
assume that any transmission instance of the primary
synchronization signal is transmitted on the same antenna port,
or ports, used for any other transmission instance of the
primary synchronization signal.
The sequence d(n) shall be mapped to the resource elements
according to
$\begin{matrix}\begin{matrix}{a}_{k , l} = d ( n ) , & n = 0 , … , 61\end{matrix} \\ k = n - 31 + \frac{{N}_{RB}^{DL} {N}_{sc}^{RB}}{2}\end{matrix}$
For frame structure type 1, the primary synchronization signal
shall be mapped to the last OFDM symbol in slots 0 and 10.
For frame structure type 2, the primary synchronization signal
shall be mapped to the third OFDM symbol in subframes 1 and 6.
Resource elements (k,l) in the OFDM symbols used for transmission
of the primary synchronization signal where
$\begin{matrix}k = n - 31 + \frac{{N}_{RB}^{DL} {N}_{sc}^{RB}}{2} \\ n = - 5 , - 4 , … , - 1 , 62 , 63 , … 66\end{matrix}$
are reserved and not used for transmission of the primary
synchronization signal.
6.11.2 Secondary synchronization signal
6.11.2.1 Sequence generation
The sequence d(0), . . . , d(61) used for the second synchronization
signal is an interleaved concatenation of two length-31 binary
sequences. The concatenated sequence is scrambled with a
scrambling sequence given by the primary synchronization
signal.
The combination of two length-31 sequences defining the
secondary synchronization signal differs between subframe 0 and
subframe 5 according to
$\begin{matrix}d ( 2 n ) = \{ \begin{matrix}{s}_{0}^{( {m}_{0} )} ( n ) {c}_{0} ( n ) & in subframe 0 \\ {s}_{1}^{( {m}_{1} )} ( n ) {c}_{0} ( n ) & in subframe 5\end{matrix} \\ d ( 2 n + 1 ) = \{ \begin{matrix}{s}_{1}^{( {m}_{1} )} ( n ) {c}_{1} ( n ) {z}_{1}^{( m 0 )} ( n ) & in subframe 0 \\ {s}_{0}^{( {m}_{0} )} ( n ) {c}_{1} ( n ) {z}_{1}^{( m 1 )} ( n ) & in subframe 5\end{matrix}\end{matrix}$
where 0 ≦ n ≦ 30. The indices m₀ and m₁ are derived from the
physical-layer cell-identity group N_{ID}⁽¹⁾ according to
$\begin{matrix}{m}_{0} = {m}^{′} mod 31 \\ {m}_{1} = ( {m}_{0} + ⌊ {m}^{′} / 31 ⌋ + 1 ) mod 31 \\ {m}^{′} = {N}_{ID}^{( 1 )} + q ( q + 1 ) / 2 , q = ⌊ \frac{{N}_{ID}^{( 1 )} + {q}^{′} ( {q}^{′} + 1 ) / 2}{30} ⌋ , {q}^{′} = ⌊ {N}_{ID}^{( 1 )} / 30 ⌋\end{matrix}$
where the output of the above expression is listed in Table
6.11.2.1-1.
The two sequences s₀^{(m0)}(n) and s₁^{(m1)}(n) are defined as two
different cyclic shifts of the m-sequence \tilde{s}(n) according to
s₀^{(m0)}(n) = \tilde{s}((n + m₀)mod31)
s₁^{(m1)}(n) = \tilde{s}((n + m₁)mod31)
where \tilde{s}(i) = 1 − 2x(i), 0 ≦ i ≦ 30, is defined by
x(ī + 5) = (x(ī + 2) + x(ī))mod 2, 0 ≦ ī ≦ 25
with initial conditions x(0) = 0, x(1) = 0, x(2) = 0, x(3) = 0, x(4) = 1.
The two scrambling sequences c₀(n) and c₁(n) depend on the primary
synchronization signal and are defined by two different cyclic
shifts of the m-sequence \tilde{c}(n) according to

c₀(n) = \tilde{c}((n + N_{ID}⁽²⁾)mod31)
c₁(n) = \tilde{c}((n + N_{ID}⁽²⁾) + 3)mod31)

where N_{ID}⁽²⁾ ε {0,1,2} is the physical-layer identity within the
physical-layer cell identity group N_{ID}⁽¹⁾ and \tilde{c}(i) = 1 − 2x(i), 0 ≦ i ≦ 30,
is defined by
x(ī + 5) = (x(ī + 3) + x(ī))mod2, 0 ≦ ī ≦ 25
with initial conditions x(0) = 0, x(1) = 0, x(2) = 0, x(3) = 0, x(4) = 1.
The scrambling sequences z₁^{(m0)}(n) and z₁^{(m1)}(n) are defined by a
cyclic shift of the m-sequence \tilde{z}(n) according to
z₁^{(m}^{₀}⁾(n) = \tilde{z}((n + (m₀ mod8))mod31)
z₁^{(m}^{₁}⁾(n) = \tilde{z}((n + (m₁ mod8))mod31)
where m₀ and m₁ are obtained from Table 6.11.2.1-1 and
\tilde{z}(i) = 1 − 2x(i), 0 ≦ i ≦ 30, is defined by
x(ī + 5) = (x(ī + 4) + x(ī + 2) + x(ī + 1) + x(ī))mod2, 0 ≦ ī ≦ 25
with initial conditions x(0) = 0, x(1) = 0, x(2) = 0, x(3) = 0, x(4) = 1.
Table 6.11.2.1-1: Mapping between physical-layer cell-identity group
N_{ID}⁽¹⁾ and the indices m₀ and m₁

| N_{ID}⁽¹⁾ | m₀ | m₁ |
|---|---|---|
| 0 | 0 | 1 |
| 1 | 1 | 2 |
| 2 | 2 | 3 |
| 3 | 3 | 4 |
| 4 | 4 | 5 |
| 5 | 5 | 6 |
| 6 | 6 | 7 |
| 7 | 7 | 8 |
| 8 | 8 | 9 |
| 9 | 9 | 10 |
| 10 | 10 | 11 |
| 11 | 11 | 12 |
| 12 | 12 | 13 |
| 13 | 13 | 14 |
| 14 | 14 | 15 |
| 15 | 15 | 16 |
| 16 | 16 | 17 |
| 17 | 17 | 18 |
| 18 | 18 | 19 |
| 19 | 19 | 20 |
| 20 | 20 | 21 |
| 21 | 21 | 22 |
| 22 | 22 | 23 |
| 23 | 23 | 24 |
| 24 | 24 | 25 |
| 25 | 25 | 26 |
| 26 | 26 | 27 |
| 27 | 27 | 28 |
| 28 | 28 | 29 |
| 29 | 29 | 30 |
| 30 | 0 | 2 |
| 31 | 1 | 3 |
| 32 | 2 | 4 |
| 33 | 3 | 5 |
| 34 | 4 | 6 |
| 35 | 5 | 7 |
| 36 | 6 | 8 |
| 37 | 7 | 9 |
| 38 | 8 | 10 |
| 39 | 9 | 11 |
| 40 | 10 | 12 |
| 41 | 11 | 13 |
| 42 | 12 | 14 |
| 43 | 13 | 15 |
| 44 | 14 | 16 |
| 45 | 15 | 17 |
| 46 | 16 | 18 |
| 47 | 17 | 19 |
| 48 | 18 | 20 |
| 49 | 19 | 21 |
| 50 | 20 | 22 |
| 51 | 21 | 23 |
| 52 | 22 | 24 |
| 53 | 23 | 25 |
| 54 | 24 | 26 |
| 55 | 25 | 27 |
| 56 | 26 | 28 |
| 57 | 27 | 29 |
| 58 | 28 | 30 |
| 59 | 0 | 3 |
| 60 | 1 | 4 |
| 61 | 2 | 5 |
| 62 | 3 | 6 |
| 63 | 4 | 7 |
| 64 | 5 | 8 |
| 65 | 6 | 9 |
| 66 | 7 | 10 |
| 67 | 8 | 11 |
| 68 | 9 | 12 |
| 69 | 10 | 13 |
| 70 | 11 | 14 |
| 71 | 12 | 15 |
| 72 | 13 | 16 |
| 73 | 14 | 17 |
| 74 | 15 | 18 |
| 75 | 16 | 19 |
| 76 | 17 | 20 |
| 77 | 18 | 21 |
| 78 | 19 | 22 |
| 79 | 20 | 23 |
| 80 | 21 | 24 |
| 81 | 22 | 25 |
| 82 | 23 | 26 |
| 83 | 24 | 27 |
| 84 | 25 | 28 |
| 85 | 26 | 29 |
| 86 | 27 | 30 |
| 87 | 0 | 4 |
| 88 | 1 | 5 |
| 89 | 2 | 6 |
| 90 | 3 | 7 |
| 91 | 4 | 8 |
| 92 | 5 | 9 |
| 93 | 6 | 10 |
| 94 | 7 | 11 |
| 95 | 8 | 12 |
| 96 | 9 | 13 |
| 97 | 10 | 14 |
| 98 | 11 | 15 |
| 99 | 12 | 16 |
| 100 | 13 | 17 |
| 101 | 14 | 18 |
| 102 | 15 | 19 |
| 103 | 16 | 20 |
| 104 | 17 | 21 |
| 105 | 18 | 22 |
| 106 | 19 | 23 |
| 107 | 20 | 24 |
| 108 | 21 | 25 |
| 109 | 22 | 26 |
| 110 | 23 | 27 |
| 111 | 24 | 28 |
| 112 | 25 | 29 |
| 113 | 26 | 30 |
| 114 | 0 | 5 |
| 115 | 1 | 6 |
| 116 | 2 | 7 |
| 117 | 3 | 8 |
| 118 | 4 | 9 |
| 119 | 5 | 10 |
| 120 | 6 | 11 |
| 121 | 7 | 12 |
| 122 | 8 | 13 |
| 123 | 9 | 14 |
| 124 | 10 | 15 |
| 125 | 11 | 16 |
| 126 | 12 | 17 |
| 127 | 13 | 18 |
| 128 | 14 | 19 |
| 129 | 15 | 20 |
| 130 | 16 | 21 |
| 131 | 17 | 22 |
| 132 | 18 | 23 |
| 133 | 19 | 24 |
| 134 | 20 | 25 |
| 135 | 21 | 26 |
| 136 | 22 | 27 |
| 137 | 23 | 28 |
| 138 | 24 | 29 |
| 139 | 25 | 30 |
| 140 | 0 | 6 |
| 141 | 1 | 7 |
| 142 | 2 | 8 |
| 143 | 3 | 9 |
| 144 | 4 | 10 |
| 145 | 5 | 11 |
| 146 | 6 | 12 |
| 147 | 7 | 13 |
| 148 | 8 | 14 |
| 149 | 9 | 15 |
| 150 | 10 | 16 |
| 151 | 11 | 17 |
| 152 | 12 | 18 |
| 153 | 13 | 19 |
| 154 | 14 | 20 |
| 155 | 15 | 21 |
| 156 | 16 | 22 |
| 157 | 17 | 23 |
| 158 | 18 | 24 |
| 159 | 19 | 25 |
| 160 | 20 | 26 |
| 161 | 21 | 27 |
| 162 | 22 | 28 |
| 163 | 23 | 29 |
| 164 | 24 | 30 |
| 165 | 0 | 7 |
| 166 | 1 | 8 |
| 167 | 2 | 9 |
| — | — | — |
| — | — | — |

6.11.2.2 Mapping to resource elements
The mapping of the sequence to resource elements depends on the
frame structure. In a subframe for frame structure type 1 and
in a half-frame for frame structure type 2, the same antenna
port as for the primary synchronization signal shall be used
for the secondary synchronization signal.
The sequence d(n) shall be mapped to resource elements according
to
$\begin{matrix}{a}_{k , l} = \begin{matrix}d ( n ) , & n = 0 , … , 61\end{matrix} \\ k = n - 31 + \frac{{N}_{RB}^{DL} {N}_{sc}^{RB}}{2} \\ l = \{ \begin{matrix}{N}_{symb}^{DL} - 2 & in slots 0 and 10 & for frame structure type 1 \\ {N}_{symb}^{DL} - 1 & in slots 1 and 11 & for frame structure type 2\end{matrix}\end{matrix}$
Resource elements (k,l) where
$\begin{matrix}k = n - 31 + \frac{{N}_{RB}^{DL} {N}_{sc}^{RB}}{2} \\ l = \{ \begin{matrix}{N}_{symb}^{DL} - 2 & in slots 0 and 10 & for frame structure type 1 \\ {N}_{symb}^{DL} - 1 & in slots 1 and 11 & for frame structure type 2\end{matrix} \\ n = - 5 , - 4 , … , - 1 , 62 , 63 , … , 66\end{matrix}$
are reserved and not used for transmission of the secondary
synchronization signal.

TABLE 9
Proximity Services
(from 3GPP TS23.202 V12.2.0):

4.5.4 ProSe UE-to-Network Relaying
ProSe UE-to-Network Relaying shall include the following
functions:

| - | ProSe Direct discovery following Model A or Model B can be used in order to allow the Remote UE to |
|---|---|
| | discover ProSe UE-to-Network Relay(s) in proximity. |
| - | ProSe Direct discovery that can be used in order to allow the Remote UE to discover L2 address of the |
| | ProSe UE-to-Network Relay to be used by the Remote UE for IP address allocation and user plane traffic |
| | corresponding to a specific PDN connection supported by the ProSe UE-to-Network Relay. |
| - | Act as an “announcing” or “discoveree” UE on the PC5 reference point supporting direct discovery. |
| - | Act as a default router to the Remote UEs forwarding IP packets between the UE-ProSe UE-to-Network |
| | Relay point-to-point link and the corresponding PDN connection. |
| - | Handle Router Solicitation and Router Advertisement messages as defined in IETF RFC 4861[10]. |
| - | Act as DHCPv4 Server and stateless DHCPv6 Relay Agent. |
| - | Act as a NAT if IPv4 is used replacing the locally assigned IPv4 address of the Remote UE with its own. |
| - | Map the L2 link ID used by the Remote UE as Destination Layer-2 ID to the corresponding PDN |

connection supported by the ProSe UE-to-Network Relay.

NOTE: The aspects of the radio layers for the PC5 reference point are defined in RAN specifications.

4.6.4.3 Identifiers for ProSe UE-to-Network Relay discovery and selection
The following information may be used for ProSe UE-to-Network
Relay discovery and selection:

| - | Message type identifier (e.g. identifying Model A or Model B discovery) |
|---|---|
| - | ProSe Relay (UE) ID: link layer identifier that is used for direct communication and is associated with a |
| | PDN connection the ProSe UE-to-Network Relay has established. |
| - | PLMN ID: this identifies the PLMN to which radio frequencies used on the link to the Remote UE belong. |
| | If these radio frequencies are shared between multiple PLMNs, or not allocated to any PLMN, then the |
| | choice of PLMN ID is configured by the HPLMN. |
| - | ProSe Application Relay Code: parameter identifying connectivity the ProSe UE-to-Network Relay |
| | provides, (e.g. including APN information). |
| - | Whether the UE can act as a relay. |
| - | Status/maintenance flags (e.g. indicating whether the relay is temporarily without connectivity or battery |

running low so the Remote UEs can seek/reselect another Relay).

Editor's note: It is FFS if additional parameters are needed in order to protect the discovery message (e.g.

restricted discovery).

The ProSe UE-to-Network Relay (to allow either Model A or Model B discovery) provides information
assisting the Remote UE to perform “relay selection” e.g. if more than one relay is “announcing” in proximity
of the Remote UE. The ProSe UE-to-Network Relay also indicates whether it supports the ability to receive
signalling from the Remote UE.
The Remote UE uses the received relay selection information to select the ProSe UE-to-Network Relay and
and selects a ProSe UE ID (of the selected ProSe UE-to-Network Relay) that corresponds to the PDN
connection it wants to connect through.

From Change Request (CR) on D2D for TS 36.331 (Standard language for 3GPP
standards):
A UE transmits SLSS, in accordance with 5.x.7.3, for every pool
and in every discovery period in which it transmits ProSe
Direct announcements for which the following conditions are
met:

| | |
|---|---|
| 1> | If the cell used to transmit Prose Direct Discovery announcement is suitable as defined in TS 36.304 [4]: |

| | |
|---|---|
| 2> | the syncSourceControl is configured and set to TRUE; or |
| 2> | the syncSourceControl is not configured; and syncTxThreshIC is included in |

SystemInformationBlockType19; and the RSRP measurement of the cell used to transmit Prose Direct
Discovery announcements is below the value of syncTxThreshIC;

A UE transmits SLSS, in accordance with 5.x.7.3, in every
Synchronisation Configuration (SC) period in which it transmits
ProSe Direct Communication for which the following conditions
are met:

| | |
|---|---|
| 1> | If the cell used to transmit Prose Direct Communication is suitable as defined in TS 36.304 [4]; or |
| 1> | If the cell used to transmit Prose Direct Communication meets the S-criteria, as defined in TS 36.304 [4], |

| and the conditions to support ProSe Direct Communication in limited service state as specified in TS | |
|---|---|
| 23.303 [N, 4.5.x] are fulfilled: | |
| 2> | if in RRC_CONNECTED; and the syncSourceControl is configured and set to TRUE; or |
| 2> | if in RRC_CONNECTED; and the syncSourceControl is not configured; and syncTxThreshIC is |
| | included in SystemInformationBlockType18; and the RSRP measurement of the cell used to transmit |
| | Prose Direct Communication is below the value of syncTxThreshIC; |
| 2> | if in RRC_IDLE; and syncTxThreshIC is included in SystemInformationBlockType18; and the RSRP |

measurement of the cell used to transmit Prose Direct Communication is below the value of
syncTxThreshIC;

| | |
|---|---|
| 1> | else: |

| | |
|---|---|
| 2> | if syncTxThreshOoC is included in the preconfigured ProSe parameters (ProsePreconfiguration defined |

in 9.x); and the RSRP measurement of the cell used to transmit Prose Direct Communication is below
the value of syncTxThreshOoC;

In every SC period in which a UE transmitting ProSe Direct
Communication transmits SLSS, it shall transmit the
MasterInformationBlock-SL message in accordance with 5.x.7.4;
5.X.7.3 Transmission of SLSS
The UE shall select the SLSS as follows:

| 1> | If the cell used to transmit Prose Direct Discovery announcement/Communication is suitable as defined in |
|---|---|
| | TS 36.304 [4]; or |
| 1> | If the cell used to transmit Prose Direct Communication meets the S-criteria, as defined in TS 36.304 [4], |

| and the conditions to support ProSe Direct Communication in limited service state as specified in TS | |
|---|---|
| 23.303 [N, 4.5.x] are fulfilled: | |
| 2> | select the SLSS included in the entry of commSyncConfig included in the received |
| | SystemInformationBlock18 or the entry of discSyncConfig included in the received |
| | SystemInformationBlock19, that includes tx-Parameters; |
| 2> | select the subframe in which to transmit the SLSS according to the received sync-OffsetIndicator |

included in the same entry of commSyncConfig/discSyncConfig as used to select the SLSS (i.e.
according to previous bullet);

| | |
|---|---|
| 1> | else (out of coverage on ProSe carrier) |

| 2> | select the synchronisation reference UE (SyncRef UE) as defined in 5.X.7.6; |
|---|---|
| 2> | if the UE has a selected SyncRef UE and inCoverage in the MIB-SL received from this UE is set to |
| | TRUE; or |
| 2> | if the UE has a selected SyncRef UE and inCoverage in the MIB-SL received from this UE is set to |

| FALSE while the SLSS from this UE is part of the set defined for in coverage, see TS 36.211 [21]: | |
|---|---|
| 3> | select the same SLSSID as the received SLSS; |
| 3> | select the subframe in which to transmit the SLSS |

according to the received sync-OffsetIndicator1 or
sync-OffsetIndicator2 included in the preconfigured
ProSe parameters (proseConfigGeneral in
ProsePreconfiguration defined in 9.x), such that the
subframe timing is different from the received SLSS;

| | |
|---|---|
| 2> | else if the UE has a selected SyncRef UE and inCoverage in the MIB-SL received from this UE is set to |

| FALSE: | |
|---|---|
| 3> | select the SLSSID from the set defined for out of |

coverage having the same index as the received SLSS;

| | |
|---|---|
| 3> | select the subframe in which to transmit the SLSS |

according to the received sync-OffsetIndicator1 or
sync-OffsetIndicator2 included in the preconfigured
ProSe parameters (proseConfigGeneral in
ProsePreconfiguration defined in 9.x), such that the
subframe timing is different from the received SLSS;

| | |
|---|---|
| 2> | else: |

| | |
|---|---|
| 3> | arbitrarily select a SLSSID from the set of sequences |

defined for out of coverage, see TS 36.211 [21];

| | |
|---|---|
| 3> | select the subframe in which to transmit the SLSS |

according to the received sync-Offset IndicatorTx
included in the preconfigured ProSe parameters
(proseConfigGeneral in ProsePreconfiguration defined in
9.x);

5.X.7.4 Transmission of MasterInformationBlock-SL message
The UE shall set the contents of the MasterInformationBlock-SL
message as follows:

| | |
|---|---|
| eNote | There are 4 syncTx UE cases: a) in network coverage, b) in coverage of syncTx UE that is in |

nework coverage, c) in coverage of syncTx UE that is not in nework coverage, d) alone.

| | |
|---|---|
| 1> | If the cell used to transmit Prose Direct Communication is suitable as defined in TS 36.304 [4]; or |
| 1> | If the cell used to transmit Prose Direct Communication meets the S-criteria, as defined in TS 36.304 [4], |

| and the conditions to support ProSe Direct Communication in limited service state as specified in TS | |
|---|---|
| 23.303 [N, 4.5.x] are fulfilled: | |
| 2> | set inCoverage to TRUE; |
| 2> | set sl-Bandwidth to the value of sl-Bandwidth as included in the received MasterInformationBlock; |
| 2> | set tdd-ConfigOoC to the value of tdd-Config as included in the received |
| | SystemInformationBlockType1; |
| 2> | if sync-InfoReserved is included in an entry of commSyncConfig from the received |

| SystemInformationBlockType18; | |
|---|---|
| 3> | set reserved to the value of sync-InfoReserved in the |

received SystemInformationBlockType18;

| | |
|---|---|
| 2> | else: |

| | |
|---|---|
| 3> | set all bits in reserved to 0; |

| | |
|---|---|
| 1> | if the UE has a selected SyncRef UE: |

| | |
|---|---|
| 2> | set inCoverage to FALSE; |
| 2> | set sl-Bandwidth, tdd-ConfigOoC and reserved to the value of the corresponding field included in the |

received MasterInformationBlock-SL;

| | |
|---|---|
| 1> | else: |

| | |
|---|---|
| 2> | set inCoverage to FALSE; |
| 2> | set sl-Bandwidth, tdd-ConfigOoC and reserved to the value of the corresponding field included in the |

preconfigured ProSe parameters (proseConfigGeneral in ProsePreconfiguration defined in 9.x);

| 1> | set directFrameNumber and directSubFrameNumber according to the subframe used to transmit the SLSS, |
|---|---|
| | as specified in 5.X.7.3; |
| 1> | submit the MasterInformationBlock-SL message to lower layers for transmission upon which the procedure |

ends;

5.X.7.5 Actions related to reception of MasterInformationBlock-SL
message
A UE receiving or transmitting ProSe Direct Communication that
has a selected SyncRef UE shall:

| | |
|---|---|
| 1> | apply the values of sl-Bandwidth and tdd-ConfigOoC if included in the received MasterInformationBlock- |

SL message;

5.X.7.6 Selection of synchronisation reference UE (SyncRef UE)
The UE shall:

| | |
|---|---|
| 1> | If there is no cell on the frequency used for Prose Direct Communication that meets the S-criteria, as |

| defined in TS 36.304 [4]: | |
|---|---|
| 2> | perform a full search (i.e. covering all subframes and all possible SLSS IDs) to detect candidate SLSS, |
| | in accordance with TS 36.133 [x] |
| 2> | when evaluating the one or more detected SLSDD, apply layer 3 filtering as specified in 5.5.3.2 using |
| | the preconfigured filterCoefficient as defined in 9.x, before using the RSRP measurement results; |
| 2> | If the UE detects multiple SLSS which L3 filtered RSRP measurement result exceeds |

| syncTxThreshOoC included in the preconfigured ProSe parameters (proseConfigGeneral in | |
|---|---|
| ProsePreconfiguration defined in 9.x) and for which the UE received the corresponding | |
| MasterInformationBlock-SL message (candidate SyncRef UEs), select a SyncRef UE according to the | |
| following priority order: | |
| 3> | UEs of which inCoverage, included in the MIB-SL |

received from this UE, is set to TRUE, starting with
the UE with the highest RSRP result;

| | |
|---|---|
| 3> | UEs of which inCoverage, included in the MIB-SL |

received from this UE, is set to FALSE, starting with
the UE with the highest RSRP result;

| | |
|---|---|
| 3> | UE which SLSS is part of the set defined for in |

coverage, starting with the UE with the highest RSRP
result;

| | |
|---|---|
| 3> | Other UEs, starting with the UE with the highest RSRP |

result;

- MasterInformationBlock-SL
The MasterInformationBlock-SL includes the information
transmitted by a UE transmitting SLSS, i.e. acting as
synchronisation reference, via SL-BCH.

Signalling radio bearer: N/A
RLC-SAP: TM
Logical channel: SBCH
Direction: UE to UE

MasterInformationBlock-SL

| -- ASN1START | |
|---|---|
| MasterInformationBlock-SL ::= | SEQUENCE { |

| | |
|---|---|
| sl-Bandwidth | ENUMERATED { |

n6, n15, n25, n50, n75, n100),

| | |
|---|---|
| tdd-ConfigOoC | BIT STRING (SIZE (3)), |
| directFrameNumber | BIT STRING (SIZE (10)), |
| directSubFrameNumber | INTEGER (0..9), |
| inCoverage-r12 | BOOLEAN, |
| reserved | BIT STRING (SIZE (20)) |

)
-- ASN1STOP

MasterInformationBlock-SL field descriptions

sl-Bandwidth
Parameter: transmission bandwidth configuration. n6 corresponds to 6 resource blocks, n15 to 15 resource blocks and
so on.
directFrameNumber
Defines the actual frame number. The subframe is indicated separately by means of field directSubFrameNumber.
inCoverage
Indicates whether or not the UE transmitting the MasterInformationBlock-SL is in E-UTRAN coverage.
- Prose-SLSSID
The IE Prose-SLSSID identifies a cell and is used by the
receiving UE to detect asynchronous neighbouring cells, and by
transmitting UEs to extend the synchronisation signals beyond
the cell's coverage area.

Prose-SLSSID information element
-- ASN1START

| | |
|---|---|
| Prose-SLSSID-r12 ::= | INTEGER (0..167) |

-- ASN1STOP

- ProseSyncConfig
The IE ProseSyncConfig specifies the configuration information
concerning reception of synchronisation signals from
neighbouring cells as well as concerning the transmission of
synchronisation signals for Prose Direct Communication and
Prose Direct Discovery.

ProseSyncConfig information element

-- ASN1START

| | |
|---|---|
| ProseSyncConfigDedicated-r12 ::= | SEQUENCE { |

| | | | |
|---|---|---|---|
| syncSourceControl-r12 | BOOLEAN | OPTIONAL | -- Need OR |

}

| | |
|---|---|
| ProseSyncConfig-r12 ::= | SEQUENCE { |

| | |
|---|---|
| sync-CP-Len-r12 | Prose-CP-Len-r12, |
| sync-OffsetIndicator-r12 | INTEGER (0..39), |
| slssid-r12 | Pros-SLSSID-r12, |
| tx-Parameters | SEQUENCE { |

| sync-TxParameters-r12 | Prose-TxParameters-r12 , | | |
|---|---|---|---|
| syncTxThreshIC-r12 | RSRP-RangeProse5-r12, | | |
| sync-InfoReserved-r12 | BIT STRING (SIZE (20)) | OPTIONAL | -- Need OR, |

| | | |
|---|---|---|
| } | OPTIONAL, | -- Need OR |

| | |
|---|---|
| rx-ParamsNCell-r12 | SEQUENCE { |

| | |
|---|---|
| physCellId-r12 | PhysCellId, |
| discoverySynchWindow-r12 | ENUMERATED (w1, w2) |

| | | |
|---|---|---|
| } | OPTIONAL | -- Need OR |

}

| | |
|---|---|
| Prose-CF-Len-r12 ::= | ENUMERATED {normal, extended} |

-- ASN1STOP
ProseSyncConfig field descriptions
rx-ConfigIndex
Index of the associated Rx pool for Prose Direct Communication or Discovery
synchOffsetIndicator
Bla
synchSourceControl
If configured, the field indicates whether the UE shall transmit D2D SSID (i.e. become synchronisation source) when
transmitting Prose Direct Communication/Discovery and while in coverage. If not configured, the UE acts in
accordance with syncTxThreshIC.
syncTxThreshIC
Indicates the threshold used while in coverage. In case the RSRP measurement of the cell used to transmit Prose
Direct Communication/Discovery annoucements, is below the level indicated by this field, the UE may transmit SLSS
(i.e. become synchronisation reference) when performing the corresponding Prose Direct transmission..

Although the description above contains many specificities, these should not be construed as limiting the scope of the technology disclosed herein but as merely providing illustrations of some of the presently preferred embodiments of the technology disclosed herein. Thus the scope of the technology disclosed herein should be determined by the appended claims and their legal equivalents. Therefore, it will be appreciated that the scope of the technology disclosed herein fully encompasses other embodiments which may become obvious to those skilled in the art, and that the scope of the technology disclosed herein is accordingly to be limited by nothing other than the appended claims, in which reference to an element in the singular is not intended to mean “one and only one” unless explicitly so stated, but rather “one or more.” All structural, chemical, and functional equivalents to the elements of the above-described preferred embodiment that are known to those of ordinary skill in the art are expressly incorporated herein by reference and are intended to be encompassed by the present claims. Moreover, it is not necessary for a device or method to address each and every problem sought to be solved by the technology disclosed herein, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. 112, sixth paragraph, unless the element is expressly recited using the phrase “means for.”

What is claimed is:

1. A wireless terminal comprising:
a receiver configured to receive signals over a radio interface;
a processor which is configured make a selection of a synchronization source from which to obtain synchronization information for use in device-to-device (D2D)/sidelink (SL) interaction when the wireless terminal is out-of-coverage of a radio access network by considering the fact that at least one of plural candidate synchronization sources is a UE-to-network relay (UTNR) wireless terminal.

2. The wireless terminal of claim 1, wherein the processor is configured to prioritize the UE-to-network relay (UTNR) wireless terminal over a non-UTNR wireless terminal in the selection of synchronization source.

3. The wireless terminal of claim 2, wherein the processor is configured to prioritize the UE-to-network relay (UTNR) wireless terminal over the non-UTNR wireless terminal during an initial synchronization procedure.

4. The wireless terminal of claim 2, wherein the processor is configured to prioritize the UE-to-network relay (UTNR) wireless terminal over the non-UTNR wireless terminal during a re-synchronization procedure.

5. The wireless terminal of claim 1, wherein the processor is configured to select as the synchronization source a UE-to-network relay (UTNR) wireless terminal which has a highest received signal strength when the wireless terminal receives synchronization signals from plural UTNR wireless terminals.

6. The wireless terminal of claim 1, wherein the processor is configured to make a determination from content of the synchronization information that a source of the synchronization information is a UE-to-network relay (UTNR) wireless terminal.

7. The wireless terminal of claim 6, wherein the content pertinent to the determination comprises a flag in a primary D2D synchronization channel.

8. The wireless terminal of claim 7, wherein the content pertinent to the determination comprises a bit in a reserved portion of a PD2DSCH channel.

9. The wireless terminal of claim 6, wherein the content pertinent to the determination comprises a relay-indicative sequence comprising the synchronization information, the relay-indicative sequence belonging to a relay-indicative subset of synchronization sequences.

10. The wireless terminal of claim 1, wherein the processor is configured to determine that at least one of plural candidate synchronization sources is a UE-to-network relay (UTNR) wireless terminal by detecting an indication in a discovery signal from the at least one candidate synchronization source that the at least one candidate synchronization source is a UE-to-network relay (UTNR) wireless terminal.

11. A method in a wireless terminal comprising:
receiving synchronization information over a radio interface from plural respective synchronization sources including a UE-to-network relay (UTNR) wireless terminal and a non-UTNR wireless terminal;
making a selection of a synchronization source from which to obtain synchronization information for use in device-to-device (D2D)/sidelink (SL) interaction when the wireless terminal is out-of-coverage of a radio access network by considering the fact that at least one of plural candidate synchronization sources is a UE-to-network relay (UTNR) wireless terminal.
